(19) United States
(12) Patent Application Publication
(10) Pub. No.: US 2025/0112711 A1
(43) Pub. Date: Apr. 3, 2025

(54) CALIBRATION FOR WIRELESS COMMUNICATION NETWORK

(71) Applicant: Telefonaktiebolaget LM Ericsson (publ), Stockholm (SE)

(72) Inventors: Magnus NILSSON, Lund (SE); Peter JAKOBSSON, Lund (SE); Robert ERIKSSON, Mölndal (SE); Wolfgang STABERG, Sandared (SE)

(21) Appl. No.: 18/728,954

(22) PCT Filed: Jan. 26, 2022
(86) PCT No.: PCT/SE2022/050073

§ 371 Date: Jul. 15, 2024

(51) Int. Cl. H04B 17/12; H04B 17/21; H04B 17/364

(52) U.S. Cl. CPC H04B 17/12; H04B 17/221; H04B 17/364

(57) ABSTRACT

There is disclosed antenna circuitry for a radio node, the antenna circuitry being connected or connectable to, and/or included in, an antenna arrangement having a plurality of antenna subarrays, the antenna circuitry being adapted to connect each of a plurality of Digital-to-Analog Converters, DACs, and/or Analog-to Digital Converters, ADCs, to a different one of the plurality of antenna subarrays for signal transmission; The antenna circuitry has a calibration network, the calibration network being adapted to provide signalling from one or more of the DACs to one or more of the ADCs. The disclosure also pertains to related devices and methods.

### TECHNICAL FIELD

This disclosure pertains to wireless communication technology, in particular for high frequencies.

### BACKGROUND

For high frequency communication, large antenna arrays are of high interest, with multiple subarrays and/or a large number of individual antenna elements (e.g., 1024 or more).

Different configurations of the subarrays may be used, e.g. depending on use case (for example, SU-MIMO or MU-MIMO).

### SUMMARY

It is an object of this disclosure to provide improved approaches of handling wireless communication, in particular regarding calibration of antenna circuitry. The approaches described are particularly suitable for millimeter wave communication, in particular for radio carrier frequencies around and/or above 24 GHz and/or 52.6 GHz, which may be considered high radio frequencies (high frequency) and/or millimeter waves. The carrier frequency/ies may be between 24 GHz (or) 52.6 and 140 GHz, e.g. with a lower border between 24, 52.6, 55, 60, 71 GHz and/or a higher border between 71, 72, 90, 114, 140 GHz or higher, in particular between 55 and 90 GHz, or between 60 and 72 GHz; however, higher frequencies may be considered, in particular frequency of 71 GHz or 72 GHz or above, and/or 100 GHz or above, and/or 140 GHz or above. The carrier frequency may in particular refer to a center frequency or maximum frequency of the carrier. The radio nodes and/or network described herein may operate in wideband, e.g. with a carrier bandwidth of 1 GHz or more, or 2 GHz or more, or even larger, e.g. 6.2 GHz or up to 8 GHz; the scheduled or allocated bandwidth may be the carrier bandwidth, or be smaller, e.g. depending on channel and/or procedure. In some cases, operation may be based on an OFDM waveform or a SC-FDM waveform (e.g., downlink and/or uplink), in particular a FDF-SC-FDM-based waveform. However, operation based on a single carrier waveform, e.g. SC-FDE (which may be pulse-shaped or Frequency Domain Filtered, e.g. based on modulation scheme and/or MCS), may be considered for downlink and/or uplink. In general, different waveforms may be used for different communication directions. Communicating using or utilising a carrier and/or beam may correspond to operating using or utilising the carrier and/or beam, and/or may comprise transmitting on the carrier and/or beam and/or receiving on the carrier and/or beam. Operation may be based on and/or associated to a numerology, which may indicate a subcarrier spacing and/or duration of an allocation unit and/or an equivalent thereof, e.g., in comparison to an OFDM based system. A subcarrier spacing or equivalent frequency interval may for example correspond to 960 kHz or more, or 1920 kHz or more, e.g. representing the bandwidth of a subcarrier or equivalent.

The approaches are particularly advantageously implemented in a future 6th Generation (6G) telecommunication network or 6G radio access technology or network (RAT/RAN), in particular according to 3GPP (3rd Generation Partnership Project, a standardisation organization). A suitable RAN may in particular be a RAN according to NR, for example release 18 or later, or LTE Evolution. However, the approaches may also be used with other RAT, for example future 5.5G systems or IEEE based systems.

Approaches described herein may provide cost savings, e.g. due to there being no need to add switches and power combiner/splitter to switch between different ADC/DAC combinations in different modes. Quick switching between modes of operation (number of subarrays with different signalling and/or targets) is facilitated.

There is disclosed antenna circuitry for a radio node. The antenna circuitry is connected or connectable to, and/or included in, an antenna arrangement comprising a plurality of antenna subarrays. The antenna circuitry is adapted to connect each of a plurality of Digitial-to-Analog Converters, DACs, and/or Analog-to Digital Converters, ADCs, to a different one of the plurality of antenna subarrays for signal transmission. The antenna circuitry comprises a calibration network, the calibration network being adapted to provide signalling from one or more of the DACs to one or more of the ADCs.

The calibration network may comprise, and/or be connected or connectable, to one or more coupling units or couplers, each coupling unit or coupler being adapted to provide and/or couple out signalling from a connection between a DAC and a subarray or an ADC and a subarray (a coupling unit or coupler may provide signalling to, and/or feed the signalling, to a ADC and/or an associated reception line). The number of DACs may be an even integer number, e.g. 4 or 8. The number of ADCs may be an even integer number, e.g. 4 or 8. The number of DACs may be the same as the number of ADCs. A DAC may provide analog signalling based on digital signalling (e.g., from digital processing), for transmission by the associated subarray. An ADC may provide digital signalling based on analog signalling, for reception and/or for digital processing. Signalling provided from one or more of the DACs to one or more of the ADC may be provided internally of the antenna circuitry, e.g. via one or more coupling units and/or one or more conductive lines or connections. The calibration network may comprise one or more combiners, which may be controllable to combine signalling from one or more feeds. For example, the combiner/s may combine signalling from one or more transmission feeds, and/or may combine one or more reception feeds to receive signalling, e.g. from the one or more transmission feeds. The calibration network may comprise one or more feeds, which may provide signalling coupled out via one or more coupling units. The signalling may be calibration signalling, and/or an IF representation of the signalling, e.g. before transferring into RF domain. The coupling units or couplers may operate at IF and/or on IF signalling representation. The calibration network may be controllable by circuitry being part of the calibration network, and/or by processing circuitry and/or the antenna circuitry, and/or the radio node. In general, signalling provided utilising the calibration network, and/or provided by or via the calibration network, may be coupled out from one or more transmission lines (e.g., using coupling unit/s or coupler/s), e.g. representing a copy of, and/or induced by signalling on the transmission line. Signalling provided utilised the calibration network, and/or provided by or via the calibration network, may be coupled into and/or fed into (e.g., using coupling unit/s or coupler/s) one or more reception lines. The signalling may be transmitted by the subarray, e.g. as a RF representation after transferring from IF to RF.

A connection between a DAC and a subarray may be represented by a transmission line for transmission of signalling by the subarray utilising the antenna circuitry (also referred to as TX IF path), and/or a connection between an ADC and the subarray may be represented by a reception line for reception of signalling by the subarray utilising the antenna circuitry (also referred to as RX IF path). A transmission line may comprise a diode blocking signalling to the DAC and/or a LPF. A reception line may comprise a diode blocking signalling from the ADC and/or a LPF. A transmission line and/or reception line may comprise one or more filters and/or one or more electronic processing components, e.g. for IF processing.

It may be considered that the calibration network may be controllable to provide signalling from one DAC to a plurality of ADCs, e.g. to all of the ADCs, and/or to an even number of ADCs, e.g. in a first calibration mode. The signalling may be provided in a (first) calibration mode, which may be controlled by, and/or switched on by, the antenna circuitry and/or processing circuitry and/or the radio node.

In a variant, the calibration network may be controllable to provide signalling from a plurality of DACs to one ADC, e.g. from all of the DACs, and/or from an even number of DACs, e.g. in a second calibration mode. The signalling may be provided in a (second) calibration mode, which may be controlled by, and/or switched on by, the antenna circuitry and/or processing circuitry and/or the radio node.

It may be considered that the antenna circuitry and/or radio node and/or calibration unit is adapted for performing calibration utilising the calibration network. Performing calibration may in general comprise compensating for phase deviation and/or time delay deviation and/or amplitude deviation (of the ADCs and/or DACs and/or the connections between ADC and/or DACs and the subarrays) determined utilising the calibration network. This may allow improved signal quality.

The antenna circuitry may be adapted for performing calibration based on a reference calibration. The reference calibration may indicate characteristics of TX IF path/s and/or RX IF path/s and/or ADCs and/or DACs, e.g. under controlled conditions, in particular controlled and/or fixed temperature.

It may be considered that the antenna circuitry is adapted for performing calibration based on calibration signalling transmitted utilising the antenna circuitry. The calibration signalling may be transmitted via one or more transmission lines.

In some variants, the antenna circuitry may provide Intermediate Frequency, IF, signal processing, in particular with the transmission line/s and/or reception line/s. Thus, IF distortions on received and transmitted signalling (in operation and/or for communication) may be ameliorated.

In general ADCs/DACs may be part of the antenna circuitry, e.g. one the same board, or may represent different circuitry, e.g., on a different board, to be connected or connectable to the antenna circuitry.

Each DAC may be associated to a different one of the plurality of subarrays, and/or each ADC may be associated to a different one of the subarrays. A subarray may comprise one or more subsubarrays, e.g. two subsubarrays for different polarisation of radio signalling. An ADC and/or DAC may be tunable and/or controllable, e.g. to compensate for deviation and/or to be calibrated. In some cases, performing calibration may comprise adapting processing to compensate, e.g. in processing circuitry and/or the antenna circuitry and/or the radio node, e.g. in digital domain and/or analog domain. The antenna circuitry and/or calibration network and/or radio node may be adapted for performing calibration based on a schedule and/or temperature drift and/or temperature measurement. Thus, suitable calibration may be performed.

There is considered a radio node for a wireless communication network, the radio node comprising antenna circuitry as described herein. The radio node may be a signalling radio node or network node, or feedback radio node or wireless device.

A method of operating a radio node is proposed. The radio node is a radio node as described herein. The method comprises performing calibration utilising the calibration network.

In general, the antenna circuitry may comprise a plurality of calibration networks, which may be connected or connectable to different antenna arrangements or arrays, and/or to different groups of subarrays, and/or to different groups of DACs and/or ADC and/or different antenna panels. The number of ADCs and/or DACs may correspond to the number of (smallest) subarrays of the antenna arrangement.

The calibration signalling may cover one or more allocation units, and/or be based on OFDM or SC-FDM or another waveform. In some cases, the calibration signalling transmitted by a transmitting subarray (or subsubarray) may cover one symbol time interval and/or allocation unit; this may allow quick calibration. The calibration signalling may cover a bandwidth in frequency domain, e.g. a number of subcarriers and/or PRBs, which may be smaller than a system or carrier bandwidth, and/or may be not larger than the system or carrier bandwidth divided by the number of LOs and/or subarrays.

An antenna arrangement may comprise one or more panels, in particular one panel on which all the subarrays and/or subsubarrays may be arranged. Different subarrays and/or subsubarrays may be associated to different ADCs and/or DACs and/or LOs; it may be considered that paired subsubarrays are associated to the same ADC and/or DAC and/or LO (local oscillator), e.g. (sub)subarrays of different polarisation may be paired.

Each DAC and/or ADC may be connected or connectable to two subarrays (or sub-subarrays), wherein the two subarrays (or subsubarrays) may be associated to different polarisations of signalling. Using different polarisations allows easy multi-layer transmissions. In general, to each subarray, there may be associated an ADC and a DAC, which may be considered to be paired and/or associated to each other.

A reference calibration may for example be a factory calibration, and/or may temperature-controlled. Information representing the reference calibration may be used for performing the calibration.

It may be considered that performing calibration may comprise transmitting calibration signalling by different subarrays and/or subsubarrays, wherein different calibration signalling may be transmitted by different subarrays and/or subsubarrays. Accordingly, different transmitting (sub)subarrays may be used. Different calibration signalling may differ regarding at least one signalling characteristic, e.g. resources and/or shift and/or sequence and/or OCC and/or polarisation. Different signalling may be transmitted at different times (e.g., different symbols, e.g. over a number of neighbouring symbols) or simultaneous; it should be noted, that the same sequence may be transmitted at different times as different calibration signalling if transmitted by different subarrays and/or sub-subarrays. Each calibration signalling may be received by a different ADC and/or receiver n chain (e.g., two receiving subarrays or subsubarrays, one of which may be the transmit-ting subarray or subsubarray). A DAC may be considered part of, and/or to represent, a transmitter chain, an ADC may be part of, and/or represent a reveiver chain. Different ADCs may be part of, and/or represent, different, separate receiver chains, and/or different DACs may be part of, and/or represent different, separate transmitter chains.

It may be considered that the calibration signalling is and/or may correspond to reference signalling, in particular reference signalling defined for communication. Such reference signalling may thus be reused, avoiding introducing new signalling. In particular, it may correspond to DM-RS or synchronisation signalling, and/or beam or user specific signalling, e.g. CSI-RS. The calibration signalling may be beam-formed, or omni-directional.

A, or each, subarray (and/or subsubarray) may be duplex capable, e.g. capable of transmitting and receiving simultaneously, e.g. by having independently operable transmitter and receiver chains.

A LO may in general provide timing and/or phase and/or frequency for associated sub-arrays and/or subsubarrays and/or circuitry or components. To a LO, there may be associated and/or connected a DAC and/or ADC and/or transmitter chain and/or receiver chain. To different LOs, there may be associated and/or connected to different DACs and/or ADCs and/or transmitter chains and/or receiver chains. The radio node may be adapted for communicating based on the calibration, and/or may be adapted for switching between SU-MIMO and/or MU-MIMO, and/or for operating based on different subarray configurations and/or combinations. Each subarray and/or subsubarray, and/or associated circuitry, e.g. BFIC, may be adapted for beamforming, in particular analog beamforming. Calibration may comprise synchronising LOs, and/or performing phase correction for one or more LOs, e.g. based on a reference calibration. An antenna arrangement may represent an antenna array, and/or may be adapted for SDM and/or FDM of different subarrays.

Antenna circuitry may comprise one or more transmitter and/or receiver chains, and/or one or more components like ADC, and/or DAC, and/or LO, and/or BFIC, and/or filter, and/or mixer, and/or power amplifier, and/or PGA, and/or phase shifter, etc.

A signalling characteristic of a message or signalling may represent and/or comprise one or more parameters or characteristics associated to the signalling and/or the message. Examples comprise message format, time domain resources and/or frequency domain resources and/or sequence and/or content and/or power level and/or duration and/or size (e.g., in bits or resources, e.g. resource elements) and/or coding and/or modulation and/or scrambling.

It may be considered that reference signalling may represent one or a plurality of signalling sequences. A sequence may for example be spread out over one or more symbol time intervals and/or allocation units. Different sequences (e.g., based on the same sequence root but shifted, and/or based on different roots) may used, or one sequence may be repeated a number of times; different sequences may have the same or different lengths. Thus, flexible reference signalling with optimised orthogonalisation may be provided. Each part of the signalling may be associated to one instance or occurrence of a sequence. Reference signalling may cover one or a plurality of symbol time intervals or allocation units. The time domain location may be before or after a random access message, e.g. before or after a scheduled data channel transmission, e.g. PDSCH.

In general, reference signalling may be repetitive, and/or comprise multiple instances of the same or different reference signals or signalling sequences. The number of instances may be represented by the number of repetitions (0 may indicate one instance or transmission only, N may represent N+1 total instances or transmissions; in some cases, different counting schemes may be used, e.g. with N indicating the total number of instances or transmissions). The number of instances may be 2, or 4, or 6, or 9, or 16, and/or may correspond to a number of parts of the reference signalling and/or a number of available reception beams (e.g., according to a capability of the WD) and/or a number of different transmission beams. In some cases, more than one instance may be associated to the same transmission beam and/or reception beam, e.g. for optimised reception.

The reference signalling may be target-specific signalling and/or beam-specific signalling (e.g. associated to a beam carrying synchronisation signalling). In particular, the reference signallling may represent and/or carry CSI-RS, or beam tracking RS, or synchronisation signalling, e.g. according to sequence or modulation symbols or waveform used.

Parameters and/or signalling characteristics of the reference signalling may comprise instances (e.g., number of RS and/or repetitions or instances) and/or sequence. In general, a reference signalling configuration may indicate and/or represent one or more of such parameters or signalling characteristics. The configuration may be based on cell ID and/or (broadcast signalling, e.g. System Information of SIB1), and/or may be UE-specifically configured or indicated. A measurement report or feedback may be transmitted as UCI or SCI. In general, the calibration signalling and/or reference signalling may be scheduled and/or transmitted in a TDD DL period, e.g. at the end and/or after a CORESET or control region (e.g, CORESETO), or before it, and/or scheduled dynamically by the control information message, e.g. before or after the data channel signalling.

A wireless device and/or feedback radio node (a wireless device may be considered an example for a feedback radio node), may in general comprise, and/or be adapted to utilise, processing circuitry and/or radio circuitry, in particular a transmitter and/or transceiver and/o receiver, to process (e.g., trigger and/or schedule) and/or transmit and/or receive signalling like data signalling and/or control signalling and/or reference signalling, and/or to perform beam switching. The feedback radio node may be adapted for monitoring, and/or be configured or configurable, with a plurality of search spaces. A wireless device or feedback radio node may be implemented as terminal or UE; in some cases, it may however be implemented as network node, in particular a base station or relay node or IAB node, in particular to provide MT (Mobile Termination) functionality for such. In general, a wireless device of feedback radio node may comprise and/or be adapted for transmission or reception diversity, and/or may be connected or connectable to, and/or comprise, antenna circuitry, and/or two or more independently operable or controllable antenna arrays or arrangements, and/or transmitter circuitries and/or antenna circuitries, and/or may be adapted to use (e.g., simultaneously) a plurality of antenna ports, e.g. controlling transmission or reception using the antenna array/s, and/or to utilise and/or operate and/or control two or more transmission sources, to which it may be connected or connectable, or which it may comprise. The feedback radio node may comprise multiple components and/or transmitters and/or transmission sources and/or TRPs (and/or be connected or connectable thereto) and/or be adapted to control transmission and/or reception from such. Any combination of units and/or devices able to control transmission on an air interface and/or in radio as described herein may be considered a transmit-ting radio node. A wireless device may adapted to perform calibration based on control signalling received.

A signalling radio node and/or network node (a network node may be considered an example of a signalling radio node) may comprise, and/or be adapted to utilise, processing circuitry and/or radio circuitry, in particular a receiver and/or transmitter and/or transceiver, to transmit and/or to process and/or receive (e.g. receive and/or demodulate and/or decode and/or perform blind detection and/or schedule or trigger) data signalling and/or control signalling and/or reference signalling, in particular first signalling and second signalling. In some cases, a signalling radio node may be a network node or base station or TRP, or may be an IAB node or relay node, e.g. providing control level functionality for such, e.g. DU and/or CU functionality. In some cases, e.g. sidelink scenarios, a signalling radio node may be implemented as a wireless device or terminal or UE. A signalling radio node or network node may comprise one or more independently operable or controllable receiving circuitries and/or antenna circuitries and/or may be adapted to utilise and/or operate to receive from one or more transmission source simultaneously and/or separately (in time domain), and/or to operate using (e.g., receiving) two or more antenna ports simultaneously, and/or may be connected and/or connectable and/or comprise multiple independently operable or controllable antennas or antenna arrays or subarrays. A signalling radio node may be adapted to transmit control signalling indicating, to a wireless device, to perform calibration.

Receiving may comprise scanning a frequency range (e.g., a carrier) for reference signalling and/or control signalling, e.g. at specific (e.g., predefined and/or configured) locations in time/frequency domain, which may be dependent on the carrier and/or system bandwidth. Such location/s may correspond to one or more locations or resource allocations configured or indicated or scheduled or allocated to a feedback radio node, e.g. scheduled dynamically or configured, e.g. with DCI and/or RRC signalling, e.g. for transmission or reception on resources allocated for data signalling or reference signalling or control signalling. Measuring may comprise sampling one or more reference signals and/or symbols thereof, and/or monitoring resources or resource elements associated to reference signalling, and/or determining a measurement result, e.g. based on the sampling and/or measurements. Measuring may pertain to, and/or comprise determining, one or more parameters (e.g., to be represented by a measurement result), e.g. a signalling strength (in particular RSRP or received energy) and/or signal quality. Measuring and/or measurement results of a set of measurement results may pertain to a (e.g., the same or equivalent) beam or beam pair or QCL identity; a measurement report may pertain to one or more beams or beam pairs or QCL identities, e.g. representing a selection of multiple (best) beams or combinations. For calibration, the calibration network may internally (of the antenna circuitry) feed signalling from one or more transmission lines into one or more reception lines, without receiving RF signalling.

An allocation unit may be considered to be associated to a type of signalling like reference signalling or control signalling or data signalling if it carries at least a component of the associated signalling, e.g. reference signalling or control signalling or data signalling (e.g., if a component of control signalling is transmitted on the allocation unit). In particular, an allocation unit may be considered to be associated to a control channel or data channel if it carries one or more bits of the channel and/or associated error coding, and/or such is transmitted in the allocation unit. An allocation unit may in particular represent a time interval, e.g. a block symbol or the duration of a SC-FDM symbol, or OFDM symbol or equivalent, and/or may be based on the numerology used for the synchronisation signalling, and/or may represent a predefined time interval. The duration (in time domain) of an allocation unit may be associated to a bandwidth in frequency domain, e.g. a subcarrier spacing or equivalent, e.g. a minimum usable bandwidth and/or a bandwidth allocation unit. It may be considered that signalling spanning an allocation unit corresponds to the allocation unit (time interval) carrying the signalling and/or signalling being transmitted (or received) in the allocation unit. Transmission of signalling and reception of signalling may be related in time by a path travel delay the signalling requires to travel from the transmitter to receiver (it may be assumed that the general arrangement in time is constant, with path delay/multi path effects having limited effect on the general arrangement of signalling in time domain). Allocation units associated to different control signallings, e.g. first control signalling and second control signalling, may be considered to be associated to each other and/or correspond to each other if they correspond to the same number of allocation unit within a control transmission time interval, and/or if they are synchronised to each other and/or are simultaneous, e.g. in two simultaneous transmissions. Similar reasoning may pertain to a control transmission time interval; the same interval for two signallings may be the intervals having the same number and/or relative location in the frame or timing structure associated to each signalling. A local oscillator (LO) may comprise and/or be represented for example by a PLL, or a VCO (Voltage Controlled Oscillator). Receiving calibration signalling (e.g., by a sub-array or subsubarray) may comprise monitoring for the specific signalling, e.g. based on a sequence and/or time/frequency resources and/or shift and/or OCC associated to the calibration signalling. Different calibration signallings may be orthogonal or quasi-orthogonal. The signalling may have a waveform based on OFDM, or SC-FDM, or another scheme, e.g. Single-Carrier.

A DFT-s-OFDM based waveform may be a waveform constructed by performing a DFT-spreading operation on modulation symbols mapped to a frequency interval (e.g., subcarriers), e.g. to provide a time-variable signal. A DFT-s-OFDM based waveform may also be referred to a SC-FDM waveform. It may be considered to provide good PAPR characteristics, allowing optimised operation of power amplifiers, in particular for high frequencies. In general, the approaches described herein may also be applicable to Single-Carrier based waveforms, e.g. FDE-based waveforms. Communication, e.g. on data channel/s and/or control channel/s, may be based on, and/o utilise, a DFT-s-OFDM based waveform, or a Single-Carrier based waveform.

There is also described a program product comprising instructions causing processing circuitry and/or antenna circuitry to control and/or perform a method as described herein.

Moreover, a carrier medium arrangement carrying and/or storing a program product as described herein is considered.

### BRIEF DESCRIPTION OF THE DRAWINGS

The drawings are provided to illustrate concepts and approaches described herein, and are not intended to limit their scope. The drawings comprise:

FIG. 1a) to d), showing exemplary scenarios for using MIMO and/or an AAS;

FIG. 2, showing an exemplary calibration scenario;

FIGS. 3a) and b), showing exemplary calibration methods as flowchart; and

FIGS. 4a) and b), showing exemplary calibration methods as flowcharts.

### DETAILED DESCRIPTION

One approach for improving system performance of a wireless communication system is to use an advanced antenna system (AAS). A phased (and/or time delay) controlled array of antennas enables beamforming of the transmitted and received signalling (RF-signal), which may be used to increase reliability, provide low latency, and/or improve capacity and/or coverage. An AAS radio node (utilising and/or comprising and/or connected to an AAS) may comprise “N” (N 1) essentially equal or similar receiver and transmitter chains. Several different techniques may be utilised to control the relative phase between RF-signals in the array. These may comprise, for example: Analog beamforming, wherein the RF-signal or LO-signal (used for up/down conversion of the wanted signal) may be delayed/phase shifted; Digital beamforming, wherein the wanted signal (example an OFDM modulated signal) may be digitally phase shifted in time or frequency domain; Hybrid beamforming, which may represent a mix of Analog and Digital beamforming. Analog beam forming may be used for high frequency systems (e.g., 24 GHz). In order to get support for MU-MIMO, V and H polarization antennas (Vertical and Horizontal, other combinations may be considered) may be used to provide two layers, and if more is needed, then the array may be divided into smaller (sub)arrays. Typically, two subarrays may be used to transmit/receive 4 layers, and four subarrays to transmit/receive 8 layers (also known as SDM). Another reason for dividing up the array into sub-arrays may be to divide up the frequency spectrum to multiple users (also known as FDM). When dividing the array into sub-arrays (example for sub-arrays) in MU-MIMO mode, individual DAC and ADC per sub-array may be used. In SU-MIMO mode (only 2 layers), then the full array is allocated to one user (assuming that user run 2×2 MIMO). In this mode, 2 ADCs/DACs for the complete array may be used. A switch network and power dividers/combiner that decide which DAC/ADC is used in MU-MIMO mode and in SU-MIMO mode may be utilised. By only using same DAC and ADC in SU-MIMO it is easy to create and coherent signal on all antenna elements. There are no coherency requirements in between the converters.

The IF switch network and power splitters add cost and may attenuate the IF-signal. Also, it takes time to switch between SU-MIMO and MU-MIMO mode. When using only one ADC and DAC in SU-MIMO, signal strength (e.g., 6 dB DR) may be lost compared to using all the ADC:s and DAC:s.

Beside the use of one dedicated DAC and/or ADC per sub-array, the array may also divided into one array for horizontal polarization and one array for vertical polarization. In general, calibration or actions or parameters (e.g., phase difference) referring to sub-subarrays and/or subarrays and/or ADC or DAC may be considered to refer to any of those, and/or a transmitter chain and/or receiver chain and/or transceiver chain, and/or LO associated thereto. It may be considered that each LO or PLL may be associated to a specific ADC and/or DAC; different LOs or PLL may be associated to different DACs and/or different ADCs, and vice versa. Calibration and/or compensation between subarrays may refer to calibration and/or compensation between circuitry and/or components associated to, and/or connected or connectable to, the subarrays, in particular ADC and/or DAC.

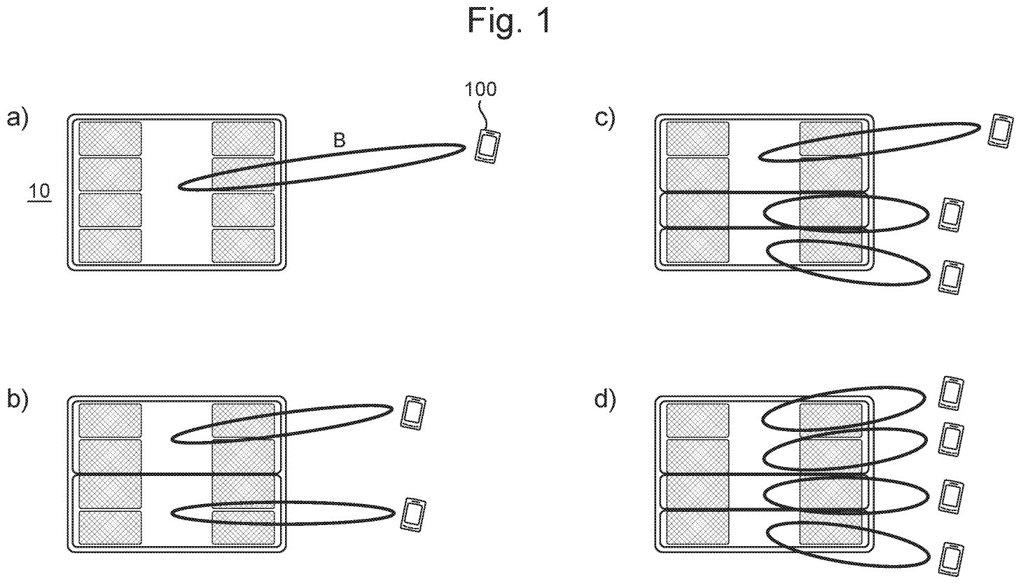

FIG. 1 shows exemplary scenarios, in which one antenna arrangement 10 representing an antenna array and/or an AAS may be used in different configurations to communicate with different numbers of user equipments 100, using different beams B. In the example, analog beamforming is used to produce the beams B; each beam is produced or associated to one sub-array of the antenna arrangement 10. FIG. 1a) to d) shows different modes of operation of the antenna array, between which it may be dynamically switched. In a), the whole antenna array 10 is used as one subarray to produce one beam (SU-MIMO case). b) to d) show different MU-MiMO scenarios, with different configurations of subarrays of the antenna array being used. There may be a configuration of smallest subarrays (e.g., d), wherein each subarray is the smallest separately controllable subarray, e.g. associated to a transmitter and/or receiver and/or transceiver chain, and/or a Local Oscillator like a PLL, and/or ADC/DCA, and/or Power Amplifier (PA). In general, a (smallest) subarray may comprise antenna elements connected or connectable to, and/or controlled and/or controllable by, the same ADC and/or DCA and/or power amplifier and/or LO or PLL.

In particular, FIG. 1 shows dynamic switching between SU-MIMO and MU-MIMO for a 4 sub-array AAS analog beamforming radio; beams may be dual polarized, e.g. by using subsubarrays of different polarisation). FIG. 1a) shows how the full array 10 is used to serve one UE 100; FIG. 1b) to d) show cases with 2, 3 and 4 UEs 100 being served simultaneously by dividing the array 10 in different subarray configurations. Transmission and/or communication may in particular be based on using SDM and/or FDM between different subarrays.

In general, a subarray may comprise and/or consist of two sub-subarrays, one for each of two different polarisations, e.g. H and V. In general, to a subarray, there may be associated a LO or PLL, and/or a BFIC and/or a DAC and/or ADC and/or a transmitter chain and/or a receiver chain (e.g., associated to and/or represented by a BFIC). A BFIC may contain LNA, and/or PA, and/or phase shifter, and/or PGA and/or combiners/splitters, and/or may comprise and/or be associated to an ADC and/or DAC. In general, a DAC may be associated to a transmission functionality and/or transmitter chain, and/or an ADC may be associated to a reception functionality and/or receiver chain.

It may be considered to perform signal mux in the digital domain, to perform multiplexing between information layers. Mode switching may now be in digital domain, which enables time accurate switching. Approaches are discussed to determine and/or control phase, amplitude and time synchronisation of the DAC/ADC:s in SU-MIMO mode, e.g. when the signal MUX is performed in digital domain. This may be necessary, e.g. if a temperature change could for instance change the anti-aliasing filters group-delay. In general, it may be considered that antenna circuitry comprises and/or provides a direct connection between the ADCs/DACs and corresponding subarrays, e.g. one ADC and/or DAC per subarray or subarray pair.

It is proposed using a calibration network that leaks signal from all DAC:s to one ADC, and from one DAC to all ADC:s. Calibrating the calibration network by recording measured phase, amplitude and delay may be considered, e.g. when OTA (Over-the-air) calibration at RF shows a coherent beam between the subarrays.

Approaches described herein provide a possibility to switch array size within a short timescale, e.g. in a cyclic prefix between two symbols (when using a waveform with cyclic prefix). Thus, all symbols may be used for communication even when switching between modes (as shown in FIG. 1). The calibration network may compensate and/or correct during run-time, and/or remove negative effects due to temperature drift. The calibration network doesn't need to be designed fully symmetrical, as it may be calibrated in a reference calibration like a factory calibration, e.g. by observing RF signals OTA.

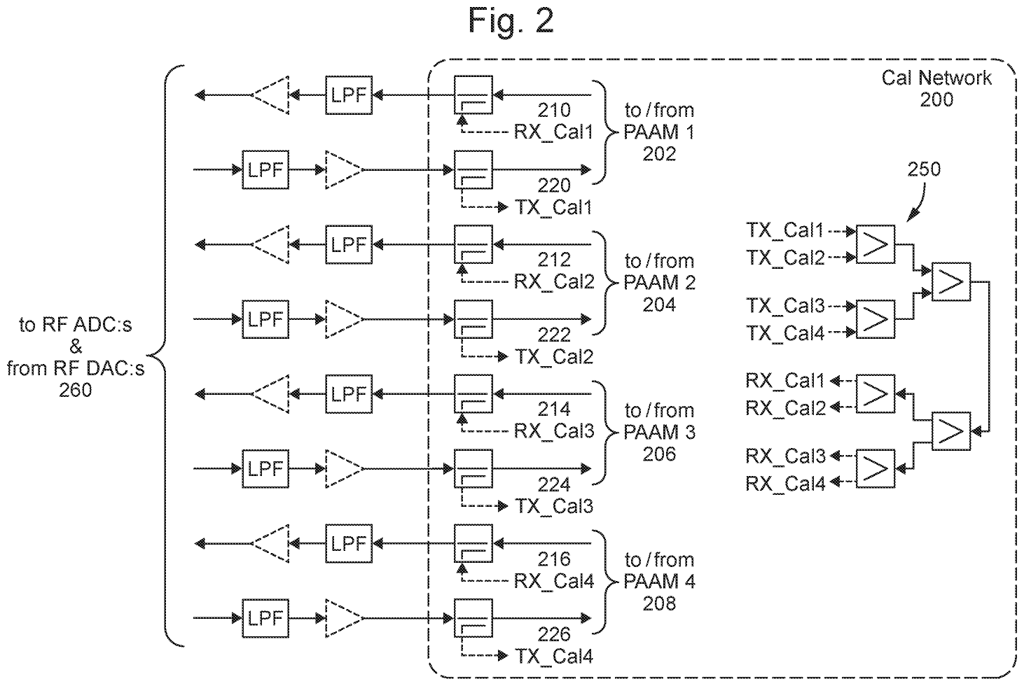

FIG. 2 shows exemplary antenna circuitry, e.g. for IF processing. A coupling or calibration network is provided between four DAC and 4 ADC to loop IF signals from one DAC to 4 ADC:s and from 4 DAC:s to one ADC. Other numbers may be possible. In particular, FIG. 2 shows exemplary antenna circuitry 200 with a calibration network. Lines 210, 220 may be connected to RF ADC and DAC (ADCs and DAC for RF are jointly referred to as 260) as well as to a subarray 202, also referred to as PAAM 1. Line 210 represents a reception (RX) line, and line 220 a transmission (TX) line, according to LPF and diode indicated in the lines. Signalling on line 210 may be coupled out by a coupling unit (or coupler) to a feed RX_{C}α11, signalling on line 220 may be coupled out by a coupling unit to a feed TXCα11. Lines 212, 222 are similarly arranged to a different DAC and ADC and subarray 204, as are lines 214, 224 to subarray 206 and lines 216 and 226 to subarray 208. RX feeds RX_{C}α12, . . . , RX_{C}α14 and transmission feeds TX_{C}a12, . . . , TX_{C}α14 to the calibration network are provided analogously. The calibration network 250 comprises a combining stage, which may combine the transmission feeds TX_{C}α11, TX_{C}α12,TX_{C}α13 and TX_{C}α14, as well as the reception feeds RX_{C}α11, RX_{C}α12, RX_{C}α13 and RX_{C}α14. The combining stage may be adapted or controllable to combine one or more of the transmission feeds, and/or one or more of the reception feeds, e.g. to provide signalling from one DAC or one transmission line to a plurality (e.g., 4) of the ADCs, and/or to provide signalling from a plurality of DACs or transmission lines (e.g., 4) to one ADC.

An antenna array may comprise a first (left) array component, and a second (right) array component. Each subarray of an array component may be connected to a different PLL or LO and/or ADC and DAC; it may be considered that to each DAC and/or DAC, there is associated one subarray of each array component. In particular, the subarrays associated to the same ADC and/or DAC may be of orthogonal polarisations (e.g., H and V, respectively) and may be considered sub-subarrays of the associated subarray.

In general, calibration signalling may be transmitted such that each transmitter (e.g., subarray) may transmit unique signalling, e.g. a unique OFDM signal per transmitting element, which may represent different subarrays transmitting different (calibration) signallings. The left and right array components may be physical separated, so noise from the PA:s in one array component may not reach the other, or only at insignificant levels.

In general, a MUX may be arranged between the DAC/LPF (or BPF) (for the IF signal) and the IF to RF up-conversion, facilitating scaling between number of simultaneous information layers and EIRP/EIS (i.e. maximum cell size). Alternative positions for the multiplexing between information layers may be considered. Beamforming may be analogue beamforming (e.g., phase shifter before the PA), but the same principles would apply for hybrid beamforming and digital beamforming. Digital mux may be placed both before and after an IFFT block, or at different portion in the DFE. The mux can for instance also be placed between DFE and DAC, or between “modulation” and IFFT function.

During reference calibration, e.g. factory calibration, the temperature of the DUT may be kept constant. By measuring the delay, phase and amplitude for the IF coupling network, reference delay, phase and amplitude may be obtained, assuming that all sub-arrays are time, phase and amplitude aligned (e.g., as determined by OTA measurements). During runtime (operation of the radio node) the temperature will change and/or be different for different DAC/ADCs. By doing scheduled or periodic measurement of the delay, phase and amplitude for the IF-coupling network, and comparing them against the values obtained during factory calibration (e.g., the reference for the TX IF and RX IF path), phase, delay or amplitude drift may be detected and then compensated for. The runtime measurement or calibration of the IF network can be triggered by a temperature change or done periodic. In general stored and/or saved data or information may be stored in the DUT and/or transferred to a radio node to be operated.

Methods described herein may be performed for or by antenna circuitry and/or a radio node and/or calibration network, which may be adapted accordingly, e.g. with suitable circuitry providing necessary control functionality.

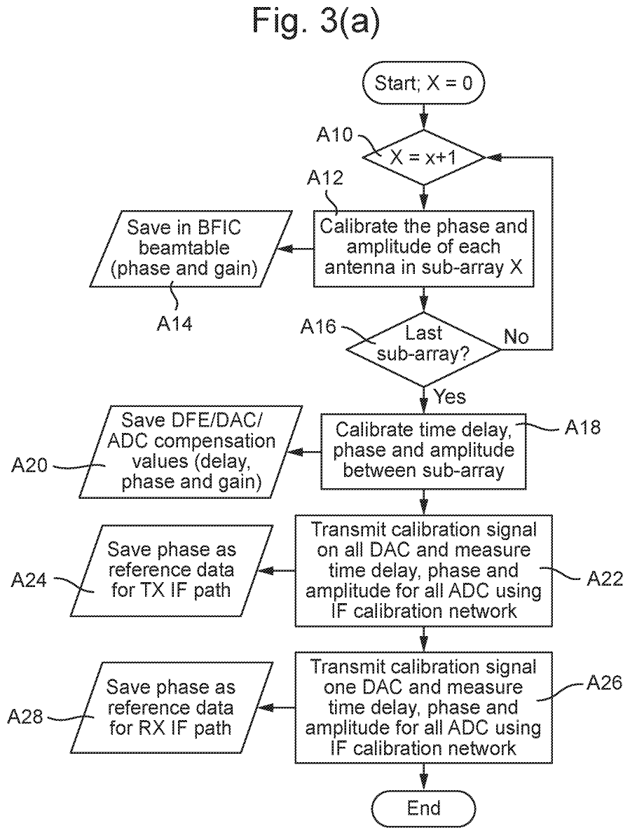

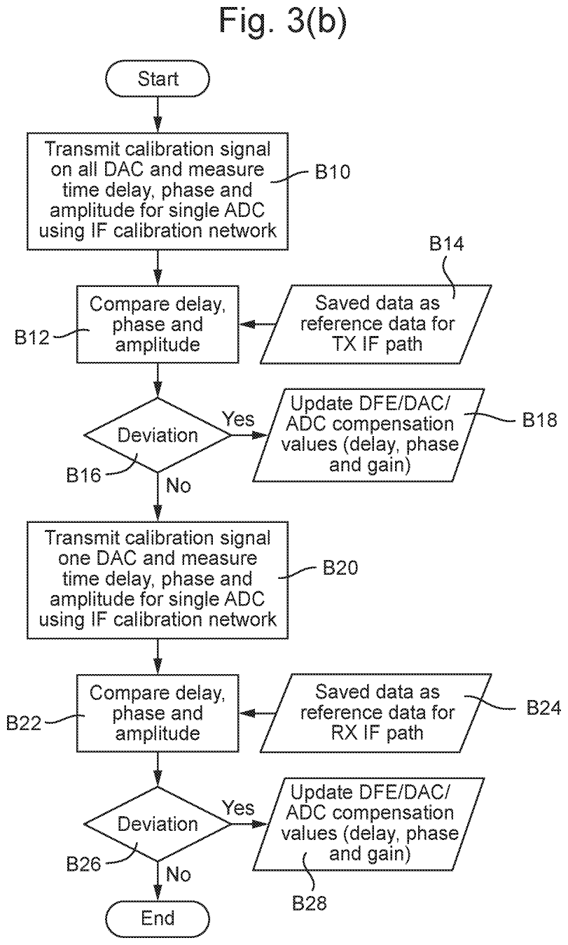

FIG. 3 shows approaches for calibration using the calibration network. FIG. 3a) shows an example of reference calibration, e.g. factory calibration. After an initialisation at start “Start, X=0”, in an action A10 “X=x+1” counter X may be increased. In an action A12 “Calibrate the phase and and amplitude of each antenna in subarray X”, calibration of the subarray X may be performed, e.g. based on OTA measurements. In an action A14 “Save in BFIC beam table (phase and gain)”, corresponding information may be stored and/or saved in a beam table. In an action A16 “Last subarray?” it may be determined whether all subarrays have been calibrated. If not, it may be looped back to A10. If yes, it may be branched to action A18. Other forms of looping over the subarrays, and/or parallel processing, may be considered. In action A18 “Calibrate time delay, phase and amplitude between subarray”, calibration and/or compensation between the subarrays may be performed. In action A20 “Save DFE/DAC/ADC compensation values (delay, phase and gain)”, corresponding compensation values (e.g., representing differences between the DAC/ADCs and/or associated subarrays) may be stored and/or saved. In an action A22 “Transmit calibration signal on all DAC and measure time delay, phase and amplitude for single ADC using IF calibration network”, a calibration signal may be transmitted using all DACs and/or subarrays connected to and/or by the calibration network, to measure time delay, phase and amplitude for a single ADC; this may be repeated for all ADCs. In action A24 “Save data as reference data for TX IF path”, corresponding information may be stored and/or saved, associated to TX for a reference calibration. In an action A26 “Transmit calibration signal on one DAC and measure time delay, phase and amplitude for all ADC using IF calibration network”, a calibration signal may be transmitted using one DAC, and time delay, phase and amplitude may be measured. This may be performed for all DACs. In action A28 “Save data as reference data for RX IF path”, corresponding information may be stored and/or saved, associated to RX for a reference calibration.

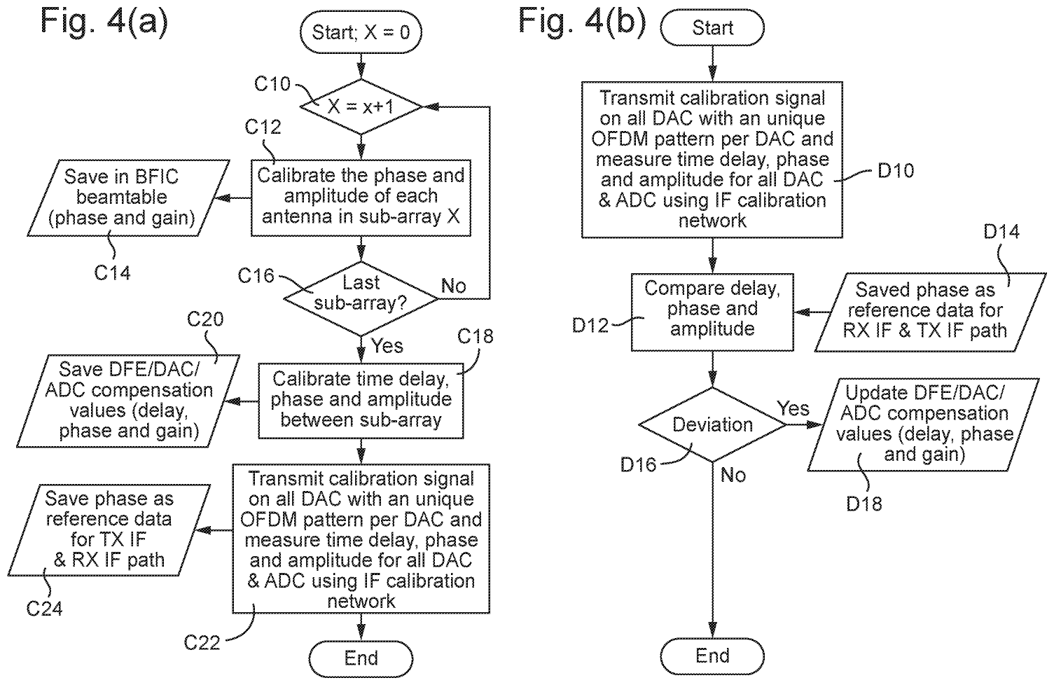

FIG. 3b) shows an example of a runtime calibration using the IF calibration network. After START, in an action B10 “Transmit calibration signal on all DAC and measure time delay, phase and amplitude for single ADC using IF calibration network”, calibration signalling may be transmitted using all DAC and/or all subarrays, to measure time delay, phase and amplitude for a single ADC. This may be performed for all ADCs. In an action B12 “Compare delay, phase and amplitude”, delay phase and amplitude for the ADC/s may be compared, e.g. based on B14 “Save data as reference data for TX IF path” using data saved as reference calibration data for TX. This data may be provided from a reference calibration, e.g. as shown in FIG. 3a). If in action B16 “Deviation” a deviation (e.g., according to one or more thresholds) is determined, in action B18 “Update DFE/DAC compensation values (delay, phase, and gain)” the deviation may be 540 compensated for, e.g. by updating corresponding values. From B18, it may be branched to B20, as may be from B16 if no deviation is determined. In action B20 “Transmit calibration signal on one DAC and measure time delay, phase and amplitude for all ADC using IF calibration network”, one DAC and/or subarray may be used for transmitting a calibration signal, to measure time delay, phase and amplitude for all ADCs. Based on the measurement, in action B22 “Compare delay, phase and amplitude” delay, phase and amplitude may be compared based on B24 “Save data as reference data for RX IF path” using data daved as reference calibration data for RX, e.g. provided from a reference calibration, e.g. as shown in FIG. 3a) or 4a). If in action B26 “Deviation”, based on B22, a deviation (e.g., according to a threshold) is determined, in action B28 “Update DFE/ADC compensation values (delay, phase, and gain)” may be performed. A different order between B10 to B16/18 and B20 to B26/28 may be considered; each action may be performed for each ADC or DAC, respectively.

FIG. 4 shows alternative methods for calibration. In one alternative option, DAC and ADC measurement may be performed at the same time. This is done by using an orthogonal OFDM signal (or other orthogonal waveform) per DAC. FIG. 4a) shows an exemplary reference calibration, e.g. a factory calibration. After start with initialisation of X=0 “Start; X=0”, in an action C10 “X=x+1”, the counter X may be incremented. In action C12 “Calibrate the phase and and amplitude of each antenna in subarray X”, calibration for subarray X may be performed, e.g. using OTA. In an action C14 “Save in BFIC beam table (phase and gain)”, corresponding information may be stored and/or saved in a beam table. In an action C16 “Last subarray?” it may be determined whether all subarrays have been calibrated. If not, it may be looped back to C10. If yes, it may be branched to action C18. Other forms of looping over the subarrays, and/or parallel processing, may be considered. In action C18 “Calibrate time delay, phase and amplitude between subarray”, calibration between the subarrays may be performed. In an action C20 “Save DFE/DAC/ADC compensation values (delay, phase and gain)” corresponding information may be stored or saved based on action C18. In an action C22 “Transmit calibration signal on all DAC with an unique OFDM pattern per DAC and measure time delay, phase and amplitude for all DAC & ADC using IF calibration network”, using each DAC, a unique calibration signal (in the example, based on OFDM may be used, other waveforms may be utilised) may be transmitted, and measurements for all DAC and ADC may be performed to measure time delay, phase and amplitude. Based on action C22, in action C24 “Save data as reference data for TX IF & RX IF path” corresponding information may be stored and/or saved as reference calibration data.

FIG. 4b) shows an exemplary alternative method of runtime calibration. After “START”, in an action D10 “Transmit calibration signal on all DAC with an unique OFDM pattern per DAC and measure time delay, phase and amplitude for all DAC & ADC using IF calibration network” using each DAC, a unique calibration signal (in the example, based on OFDM may be used, other waveforms may be utilised) may be transmitted, and measurements for all DAC and ADC may be performed to measure time delay, phase and amplitude. In action D12 “Compare delay, phase and amplitude”, based on D14 “Save data as reference data for RX IF & TX IF path” and using data saved as reference calibration data (e.g., based on a reference calibration as shown in FIG. 3a) or 4a)), a comparison of delay, phase and amplitude may be performed. In action D16 “Deviation”, based on D12, a deviation of phase, delay and/or amplitude may be determined (e.g., based on one or more thresholds). If a deviation is determined, in action D18 “Update DFE/DAC/ADC compensation values (delay, phase and gain)”, the deviations may be compensated for.

In general, a block symbol may represent and/or correspond to an extension in time domain, e.g. a time interval. A block symbol duration (the length of the time interval) may correspond to the duration of an OFDM symbol or a corresponding duration, and/or may be based and/or defined by a subcarrier spacing used (e.g., based on the numerology) or equivalent, and/or may correspond to the duration of a modulation symbol (e.g., for OFDM or similar frequency domain multiplexed types of signalling). It may be considered that a block symbol comprises a plurality of modulation symbols, e.g. based on a subcarrier spacing and/or numerology or equivalent, in particular for time domain multiplexed types (on the symbol level for a single transmitter) of signalling like single-carrier based signalling, e.g. SC-FDE or SC-FDMA (in particular, FDF-SC-FDMA or pulse-shaped SC-FDMA). The number of symbols may be based on and/or defined by the number of subcarrier to be DFTS-spread (for SC-FDMA) and/or be based on a number of FFT samples, e.g. for spreading and/or mapping, and/or equivalent, and/or may be predefined and/or configured or configurable. A block symbol in this context may comprise and/or contain a plurality of individual modulation symbols, which may be for example 1000 or more, or 3000 or more, or 3300 or more. The number of modulation symbols in a block symbol may be based and/or be dependent on a bandwidth scheduled for transmission of signalling in the block symbol. A block symbol and/or a number of block symbols (an integer smaller than 20, e.g. equal to or smaller than 14 or 7 or 4 or 2 or a flexible number) may be a unit (e.g., allocation unit) used for scheduling and/or allocation of resources, in particular in time domain. To a block symbol (e.g., scheduled or allocated) and/or block symbol group and/or allocation unit, there may be associated a frequency range and/or frequency domain allocation and/or bandwidth allocated for transmission.

An allocation unit, and/or a block symbol, may be associated to a specific (e.g., physical) channel and/or specific type of signalling, for example reference signalling. In some cases, there may be a block symbol associated to a channel that also is associated to a form of reference signalling and/or pilot signalling and/or tracking signalling associated to the channel, for example for timing purposes and/or decoding purposes (such signalling may comprise a low number of modulation symbols and/or resource elements of a block symbol, e.g. less than 10% or less than 5% or less than 1% of the modulation symbols and/or resource elements in a block symbol). To a block symbol, there may be associated resource elements; a resource element may be represented in time/frequency domain, e.g. by the smallest frequency unit carrying or mapped to (e.g., a subcarrier) in frequency domain and the duration of a modulation symbol in time domain. A block symbol may comprise, and/or to a block symbol may be associated, a structure allowing and/or comprising a number of modulation symbols, and/or association to one or more channels (and/or the structure may dependent on the channel the block symbol is associated to and/or is allocated or used for), and/or reference signalling (e.g., as discussed above), and/or one or more guard periods and/or transient periods, and/or one or more affixes (e.g., a prefix and/or suffix and/or one or more infixes (entered inside the block symbol)), in particular a cyclic prefix and/or suffix and/or infix. A cyclic affix may represent a repetition of signalling and/or modulation symbol/s used in the block symbol, with possible slight amendments to the signalling structure of the affix to provide a smooth and/or continuous and/or differentiable connection between affix signalling and signalling of modulation symbols associated to the content of the block symbol (e.g., channel and/or reference signalling structure). In some cases, in particular some OFDM-based waveforms, an affix may be included into a modulation symbol. In other cases, e.g. some single carrier-based waveforms, an affix may be represented by a sequence of modulation symbols within the block symbol. It may be considered that in some cases a block symbol is defined and/or used in the context of the associated structure.

Communicating may comprise transmitting or receiving. It may be considered that communicating like transmitting signalling is based on a SC-FDM based waveform, and/or corresponds to a Frequency Domain Filtered (FDF) DFTS-OFDM waveform. However, the approaches may be applied to a Single Carrier based waveform, e.g. a SC-FDM or SC-FDE-waveform, which may be pulse-shaped/FDF-based. It should be noted that SC-FDM may be considered DFT-spread OFDM, such that SC-FDM and DFTS-OFDM may be used interchangeably. Alternatively, or additionally, the signalling (e.g., first signalling and/or second signalling) and/or beam/s (in particular, the first received beam and/or second received beam) may be based on a waveform with CP or comparable guard time.

The received beam and the transmission beam of the first beam pair may have the same (or similar) or different angular and/or spatial extensions; the received beam and the transmission beam of the second beam pair may have the same (or similar) or different angular and/or spatial extensions. It may be considered that the received beam and/or transmission beam of the first and/or second beam pair have angular extension of 20 degrees or less, or 15 degrees or less, or 10 or 5 degrees or less, at least in one of horizontal or vertical direction, or both; different beams may have different angular extensions. An extended guard interval or switching protection interval may have a duration corresponding to essentially or at least N CP (cyclic prefix) durations or equivalent duration, wherein N may be 2, or 3 or 4. An equivalent to a CP duration may represent the CP duration associated to signalling with CP (e.g., SC-FDM-based or OFDM-based) for a waveform without CP with the same or similar symbol time duration as the signalling with CP. Pulse-shaping (and/or performing FDF for) a modulation symbol and/or signalling, e.g. associated to a first subcarrier or bandwidth, may comprise mapping the modulation symbol (and/or the sample associated to it after FFT) to an associated second subcarrier or part of the bandwidth, and/or applying a shaping operation regarding the power and/or amplitude and/or phase of the modulation symbol on the first subcarrier and the second subcarrier, wherein the shaping operation may be according to a shaping function.

Pulse-shaping signalling may comprise pulse-shaping one or more symbols; pulse-shaped signalling may in general comprise at least one pulse-shaped symbol. Pulse-shaping may be performed based on a Nyquist-filter. It may be considered that pulse-shaping is performed based on periodically extending a frequency distribution of modulation symbols (and/or associated samples after FFT) over a first number of subcarrier to a larger, second number of subcarriers, wherein a subset of the first number of subcarriers from one end of the frequency distribution is appended at the other end of the first number of subcarriers.

In some variants, communicating may be based on a numerology (which may, e.g., be represented by and/or correspond to and/or indicate a subcarrier spacing and/or symbol time length) and/or an SC-FDM based waveform (including a FDF-DFTS-FDM based waveform) or a single-carrier based waveform. Whether to use pulse-shaping or FDF on a SC-FDM or SC-based waveform may depend on the modulation scheme (e.g., MCS) used. Such waveforms may utilise a cyclic prefix and/or benefit particularly from the described approaches. Communicating may comprise and/or be based on beamforming, e.g. transmission beamforming and/or reception beamforming, respectively. It may be considered that a beam is produced by performing analog beamforming to provide the beam, e.g. a beam corresponding to a reference beam. Thus, signalling may be adapted, e.g. based on movement of the communication partner. A beam may for example be produced by performing analog beamforming to provide a beam corresponding to a reference beam. This allows efficient postprocessing of a digitally formed beam, without requiring changes to a digital beamforming chain and/or without requiring changes to a standard defining beam forming precoders. In general, a beam may be produced by hybrid beamforming, and/or by digital beamforming, e.g. based on a precoder. This facilitates easy processing of beams, and/or limits the number of power amplifiers/ADC/DCA required for antenna arrangements. It may be considered that a beam is produced by hybrid beamforming, e.g. by analog beamforming performed on a beam representation or beam formed based on digital beamforming. Monitoring and/or performing cell search may be based on reception beamforming, e.g. analog or digital or hybrid reception beamforming.

The numerology may determine the length of a symbol time interval and/or the duration of a cyclic prefix. The approaches described herein are particularly suitable to SC-FDM, to ensure orthogonality, in particular subcarrier orthogonality, in corresponding systems, but may be used for other waveforms. Communicating may comprise utilising a waveform with cyclic prefix. The cyclic prefix may be based on a numerology, and may help keeping signalling orthogonal. Communicating may comprise, and/or be based on performing cell search, e.g. for a wireless device or terminal, or may comprise transmitting cell identifying signalling and/or a selection indication, based on which a radio node receiving the selection indication may select a signalling bandwidth from a set of signalling bandwidths for performing cell search.

A beam or beam pair may in general be targeted at one radio node, or a group of radio nodes and/or an area including one or more radio nodes. In many cases, a beam or beam pair may be receiver-specific (e.g., UE-specific), such that only one radio node is served per beam/beam pair. A beam pair switch or switch of received beam (e.g., by using a different reception beam) and/or transmission beam may be performed at a border of a transmission timing structure, e.g. a slot border, or within a slot, for example between symbols. Some tuning of radio circuitry, e.g. for receiving and/or transmitting, may be performed. Beam pair switching may comprise switching from a second received beam to a first received beam, and/or from a second transmission beam to a first transmission beam. Switching may comprise inserting a guard period to cover retuning time; however, circuitry may be adapted to switch sufficiently quickly to essentially be instantaneous; this may in particular be the case when digital reception beamforming is used to switch reception beams for switching received beams.

A reference beam (or reference signalling beam) may be a beam comprising reference signalling, based on which for example a of beam signalling characteristics may be determined, e.g. measured and/or estimated. A signalling beam may comprise signalling like control signalling and/or data signalling and/or reference signalling. A reference beam may be transmitted by a source or transmitting radio node, in which case one or more beam signalling characteristics may be reported to it from a receiver, e.g. a wireless device. However, in some cases it may be received by the radio node from another radio node or wireless device. In this case, one or more beam signalling characteristics may be determined by the radio node. A signalling beam may be a transmission beam, or a reception beam. A set of signalling characteristics may comprise a plurality of subsets of beam signalling characteristics, each subset pertaining to a different reference beam. Thus, a reference beam may be associated to different beam signalling characteristics.

A beam signalling characteristic, respectively a set of such characteristics, may represent and/or indicate a signal strength and/or signal quality of a beam and/or a delay characteristic and/or be associated with received and/or measured signalling carried on a beam. Beam signalling characteristics and/or delay characteristics may in particular pertain to, and/or indicate, a number and/or list and/or order of beams with best (e.g., lowest mean delay and/or lowest spread/range) timing or delay spread, and/or of strongest and/or best quality beams, e.g. with associated delay spread. A beam signalling characteristic may be based on measurement/s performed on reference signalling carried on the reference beam it pertains to. The measurement/s may be performed by the radio node, or another node or wireless device. The use of reference signalling allows improved accuracy and/or gauging of the measurements. In some cases, a beam and/or beam pair may be represented by a beam identity indication, e.g. a beam or beam pair number. Such an indication may be represented by one or more signalling sequences (e.g., a specific reference signalling sequences or sequences), which may be transmitted on the beam and/or beam pair, and/or a signalling characteristic and/or a resource/s used (e.g., time/frequency and/or code) and/or a specific RNTI (e.g., used for scrambling a CRC for some messages or transmissions) and/or by information provided in signalling, e.g. control signalling and/or system signalling, on the beam and/or beam pair, e.g. encoded and/or provided in an information field or as information element in some form of message of signalling, e.g. DCI and/or MAC and/or RRC signalling.

A reference beam may in general be one of a set of reference beams, the second set of reference beams being associated to the set of signalling beams. The sets being associated may refer to at least one beam of the first set being associated and/or corresponding to the second set (or vice versa), e.g. being based on it, for example by having the same analog or digital beamforming parameters and/or precoder and/or the same shape before analog beamforming, and/or being a modified form thereof, e.g. by performing additional analog beamforming. The set of signalling beams may be referred to as a first set of beams, a set of corresponding reference beams may be referred to as second set of beams.

In some variants, a reference beam and/or reference beams and/or reference signalling may correspond to and/or carry random access signalling, e.g. a random access preamble. Such a reference beam or signalling may be transmitted by another radio node. The signalling may indicate which beam is used for transmitting. Alternatively, the reference beams may be beams receiving the random access signalling. Random access signalling may be used for initial connection to the radio node and/or a cell provided by the radio node, and/or for reconnection. Utilising random access signalling facilitates quick and early beam selection.

The random access signalling may be on a random access channel, e.g. based on broadcast information provided by the radio node (the radio node performing the beam selection), e.g. with synchronisation signalling (e.g., SSB block and/or associated thereto). The reference signalling may correspond to synchronisation signalling, e.g. transmitted by the radio node in a plurality of beams. The characteristics may be reported on by a node receiving the synchronisation signalling, e.g. in a random access process, e.g. a msg3 for contention resolution, which may be transmitted on a physical uplink shared channel based on a resource allocation provided by the radio node.

A delay characteristic (which may correspond to delay spread information) and/or a measurement report may represent and/or indicate at least one of mean delay, and/or delay spread, and/or delay distribution, and/or delay spread distribution, and/or delay spread range, and/or relative delay spread, and/or energy (or power) distribution, and/or impulse response to received signalling, and/or the power delay profile of the received signals, and/or power delay profile related parameters of the received signal. A mean delay may represent the mean value and/or an averaged value of the delay spread, which may be weighted or unweighted. A distribution may be distribution over time/delay, e.g. of received power and/or energy of a signal. A range may indicate an interval of the delay spread distribution over time/delay, which may cover a predetermined percentage of the delay spread respective received energy or power, e.g. 50% or more, 75% or more, 90% or more, or 100%. A relative delay spread may indicate a relation to a threshold delay, e.g. of the mean delay, and/or a shift relative to an expected and/or configured timing, e.g. a timing at which the signalling would have been expected based on the scheduling, and/or a relation to a cyclic prefix duration (which may be considered on form of a threshold). Energy distribution or power distribution may pertain to the energy or power received over the time interval of the delay spread. A power delay profile may pertain to representations of the received signals, or the received signals energy/power, across time/delay. Power delay profile related parameters may pertain to metrics computed from the power delay profile. Different values and forms of delay spread information and/or report may be used, allowing a wide range of capabilities. The kind of information represented by a measurement report may be predefined, or be configured or configurable, e.g. with a measurement configuration and/or reference signalling configuration, in particular with higher layer signalling like RRC or MAC signalling and/or physical layer signalling like DCI signalling.

In general, different beam pair may differ in at least one beam; for example, a beam pair using a first received beam and a first transmission beam may be considered to be different from a second beam pair using the first received beam and a second transmission beam. A transmission beam using no precoding and/or beamforming, for example using the natural antenna profile, may be considered as a special form of transmission beam of a transmission beam pair. A beam may be indicated to a radio node by a transmitter with a beam indication and/or a configuration, which for example may indicate beam parameters and/or time/frequency resources associated to the beam and/or a transmission mode and/or antenna profile and/or antenna port and/or precoder associated to the beam. Different beams may be provided with different content, for example different received beams may carry different signalling; however, there may be considered cases in which different beams carry the same signalling, for example the same data signalling and/or reference signalling. The beams may be transmitted by the same node and/or transmission point and/or antenna arrangement, or by different nodes and/or transmission points and/or antenna arrangements.

Communicating utilising a beam pair or a beam may comprise receiving signalling on a received beam (which may be a beam of a beam pair), and/or transmitting signalling on a beam, e.g. a beam of a beam pair. The following terms are to be interpreted from the point of view of the referred radio node: a received beam may be a beam carrying signalling received by the radio node (for reception, the radio node may use a reception beam, e.g. directed to the received beam, or be non-beamformed). A transmission beam may be a beam used by the radio node to transmit signalling. A beam pair may consist of a received beam and a transmission beam. The transmission beam and the received beam of a beam pair may be associated to each and/or correspond to each other, e.g. such that signalling on the received beam and signalling on a transmission beam travel essentially the same path (but in opposite directions), e.g. at least in a stationary or almost stationary condition. It should be noted that the terms “first” and “second” do not necessarily denote an order in time; a second signalling may be received and/or transmitted before, or in some cases simultaneous to, first signalling, or vice versa. The received beam and transmission beam of a beam pair may be on the same carrier or frequency range or bandwidth part, e.g. in a TDD operation; however, variants with FDD may be considered as well. Different beam pairs may operate on the same frequency ranges or carriers or bandwidth parts (e.g., such that transmission beams operate on the same frequency range or carriers or bandwidth part, and received beams on the same frequency range or carriers or bandwidth part (the transmission beam and received beams may be on the same or different ranges or carriers or BWPs). Communicating utilizing a first beam pair and/or first beam may be based on, and/or comprise, switching from the second beam pair or second beam to the first beam pair or first beam for communicating. The switching may be controlled by the network, for example a network node (which may be the source or transmitter of the received beam of the first beam pair and/or second beam pair, or be associated thereto, for example associated transmission points or nodes in dual connectivity). Such controlling may comprise transmitting control signalling, e.g. physical layer signalling and/or higher layer signalling. In some cases, the switching may be performed by the radio node without additional control signalling, for example based on measurements on signal quality and/or signal strength of beam pairs (e.g., of first and second received beams), in particular the first beam pair and/or the second beam pair. For example, it may be switched to the first beam pair (or first beam) if the signal quality or signal strength measured on the second beam pair (or second beam) is considered to be insufficient, and/or worse than corresponding measurements on the first beam pair indicate. Measurements performed on a beam pair (or beam) may in particular comprise measurements performed on a received beam of the beam pair. It may be considered that the timing indication may be determined before switching from the second beam pair to the first beam pair for communicating. Thus, the synchronization may be in place and/or the timing indication may be available for synchronising) when starting communication utilizing the first beam pair or first beam. However, in some cases the timing indication may be determined after switching to the first beam pair or first beam. This may be in particular useful if first signalling is expected to be received after the switching only, for example based on a periodicity or scheduled timing of suitable reference signalling on the first beam pair, e.g. first received beam. In general, a reception beam of a node may be associated to and/or correspond to a transmission beam of the node, e.g. such that the (spatial) angle of reception of the reception beam and the (spatial) angle of transmission of the transmission beam at least partially, or essentially or fully, overlap and/or coincide, in particular for TDD operation and/or independent of frequency. Spatial correspondence between beams may be considered in some cases, e.g. such that a beam pair (e.g., transmission beam of a transmitting node and reception beam of a receiving node) may be considered to comprise corresponding beams (e.g., the reception beam is suitable and/or the best beam to receive transmissions on the transmission beam, e.g. based on a threshold signal quality and/or signal strength and/or measurements); to each of such beams, there may be an associated or corresponding complementary beam of the respective node (e.g., to a transmission beam of a beam pair, there may be associated a reception beam of the transmitting node, and/or to the reception beam of a beam pair, there may be associated a transmitting beam of the receiving node; if the beams (e.g., at least essentially or substantially) overlap (e.g., in spatial angle), in some cases a beam pair may be considered to indicate four beams (or actually, two beam pairs).

In some variants, reference signalling may be and/or comprise CSI-RS, e.g. transmitted by the network node. In other variants, the reference signalling may be transmitted by a UE, e.g. to a network node or other UE, in which case it may comprise and/or be Sounding Reference signalling. Other, e.g. new, forms of reference signalling may be considered and/or used. In general, a modulation symbol of reference signalling respectively a resource element carrying it may be associated to a cyclic prefix.

Data signalling may be on a data channel, for example on a PDSCH or PSSCH, or on a dedicated data channel, e.g. for low latency and/or high reliability, e.g. a URLLC channel. Control signalling may be on a control channel, for example on a common control channel or a PDCCH or PSCCH, and/or comprise one or more DCI messages or SCI messages. Reference signalling may be associated to control signalling and/or data signalling, e.g. DM-RS and/or PT-RS.

Reference signalling, for example, may comprise DM-RS and/or pilot signalling and/or discovery signalling and/or synchronisation signalling and/or sounding signalling and/or phase tracking signalling and/or cell-specific reference signalling and/or user-specific signalling, in particular CSI-RS. Reference signalling in general may be signalling with one or more signalling characteristics, in particular transmission power and/or sequence of modulation symbols and/or resource distribution and/or phase distribution known to the receiver. Thus, the receiver can use the reference signalling as a reference and/or for training and/or for compensation. The receiver can be informed about the reference signalling by the transmitter, e.g. being configured and/or signalling with control signalling, in particular physical layer signalling and/or higher layer signalling (e.g., DCI and/or RRC signalling), and/or may determine the corresponding information itself, e.g. a network node configuring a UE to transmit reference signalling. Reference signalling may be signalling comprising one or more reference symbols and/or structures. Reference signalling may be adapted for gauging and/or estimating and/or representing transmission conditions, e.g. channel conditions and/or transmission path conditions and/or channel (or signal or transmission) quality. It may be considered that the transmission characteristics (e.g., signal strength and/or form and/or modulation and/or timing) of reference signalling are available for both transmitter and receiver of the signalling (e.g., due to being predefined and/or configured or configurable and/or being communicated). Different types of reference signalling may be considered, e.g. pertaining to uplink, downlink or sidelink, cell-specific (in particular, cell-wide, e.g., CRS) or device or user specific (addressed to a specific target or user equipment, e.g., CSI-RS), demodulation-related (e.g., DMRS) and/or signal strength related, e.g. power-related or energy-related or amplitude-related (e.g., SRS or pilot signalling) and/or phase-related, etc.

References to specific resource structures like an allocation unit and/or block symbol and/or block symbol group and/or transmission timing structure and/or symbol and/or slot and/or mini-slot and/or subcarrier and/or carrier may pertain to a specific numerology, which may be predefined and/or configured or configurable. A transmission timing structure may represent a time interval, which may cover one or more symbols. Some examples of a transmission timing structure are transmission time interval (TTI), subframe, slot and mini-slot. A slot may comprise a predetermined, e.g. predefined and/or configured or configurable, number of symbols, e.g. 6 or 7, or 12 or 14. A mini-slot may comprise a number of symbols (which may in particular be configurable or configured) smaller than the number of symbols of a slot, in particular 1, 2, 3 or 4, or more symbols, e.g. less symbols than symbols in a slot. A transmission timing structure may cover a time interval of a specific length, which may be dependent on symbol time length and/or cyclic prefix used. A transmission timing structure may pertain to, and/or cover, a specific time interval in a time stream, e.g. synchronized for communication. Timing structures used and/or scheduled for transmission, e.g. slot and/or mini-slots, may be scheduled in relation to, and/or synchronized to, a timing structure provided and/or defined by other transmission timing structures. Such transmission timing structures may define a timing grid, e.g., with symbol time intervals within individual structures representing the smallest timing units. Such a timing grid may for example be defined by slots or subframes (wherein in some cases, subframes may be considered specific variants of slots). A transmission timing structure may have a duration (length in time) determined based on the durations of its symbols, possibly in addition to cyclic prefix/es used. The symbols of a transmission timing structure may have the same duration, or may in some variants have different duration. The number of symbols in a transmission timing structure may be predefined and/or configured or configurable, and/or be dependent on numerology. The timing of a mini-slot may generally be configured or configurable, in particular by the network and/or a network node. The timing may be configurable to start and/or end at any symbol of the transmission timing structure, in particular one or more slots. There is generally considered a program product comprising instructions adapted for causing processing and/or control circuitry to carry out and/or control any method described herein, in particular when executed on the processing and/or control circuitry. Also, there is considered a carrier medium arrangement carrying and/or storing a program product as described herein.

A carrier medium arrangement may comprise one or more carrier media. Generally, a carrier medium may be accessible and/or readable and/or receivable by processing or control circuitry. Storing data and/or a program product and/or code may be seen as part of carrying data and/or a program product and/or code. A carrier medium generally may comprise a guiding/transporting medium and/or a storage medium. A guiding/transporting medium may be adapted to carry and/or carry and/or store signals, in particular electromagnetic signals and/or electrical signals and/or magnetic signals and/or optical signals. A carrier medium, in particular a guiding/transporting medium, may be adapted to guide such signals to carry them. A carrier medium, in particular a guiding/transporting medium, may comprise the electromagnetic field, e.g. radio waves or microwaves, and/or optically transmissive material, e.g. glass fiber, and/or cable. A storage medium may comprise at least one of a memory, which may be volatile or non-volatile, a buffer, a cache, an optical disc, magnetic memory, flash memory, etc.

A system comprising one or more radio nodes as described herein, in particular a network node and a user equipment, is described. The system may be a wireless communication system, and/or provide and/or represent a radio access network.

A signalling sequence may correspond to a sequence of modulation symbols (e.g., in time domain, or in frequency domain for an OFDM system). The signalling sequence may be predefined, or configured or configurable, e.g. to a wireless device. For OFDM or SC-FDM, each element of a signalling sequence may be mapped to a subcarrier; in general, for SC-based signalling, a corresponding mapping in time domain may be utilised (for example, such that each element may use essentially the full synchronisation bandwidth). A signalling sequence may comprise (ordered) modulation symbols, each modulation symbol representing a value of the sequence it is based on, e.g. based on the modulation scheme used and/or in a phase or constellation diagram; for some sequences like Zadoff-Chu sequences, there may be a mapping between non-integer sequence elements and transmitted waveform, which may not be represented in the context of a modulation scheme like BPSK or QPSK or higher. A signalling sequence may be a physical layer signalling or signal, which may be devoid of higher layer information. A signalling sequence may be based on a sequence, e.g. a bit sequence or symbol sequence and/or a modulation, e.g. performed on the sequence. Elements of a signalling sequence may be mapped to frequency domain (e.g., to subcarriers, in particular in a pattern like a comb structure or in interlaces) and/or in time domain, e.g. to one or more allocation units or symbol time intervals. A DFT-s-OFDM based waveform may be a waveform constructed by performing a DFT-spreading operation on modulation symbols mapped to a frequency interval (e.g., subcarriers), e.g. to provide a time-variable signal. A DFT-s-OFDM based waveform may also be referred to a SC-FDM waveform. It may be considered to provide good PAPR characteristics, allowing optimised operation of power amplifiers, in particular for high frequencies. In general, the approaches described herein may also be applicable to Single-Carrier based waveforms, e.g. FDE-based waveforms. Communication, e.g. on data channel/s and/or control channel/s, may be based on, and/o utilise, a DFT-s-OFDM based waveform, or a Single-Carrier based waveform.

A sequence may generally be considered to be based on a root sequence if it can be constructed from the root sequence (or represents it directly), e.g. by shifting in phase and/or frequency and/or time domain, and/or performing a cyclic shift and/or a cyclic extension, and/or copying/repeating and/or processing or operating on with a code, and/or interleaving or re-ordering of elements of the sequence, and/or extending or shortening the root sequence. A cyclic extension of a sequence may comprise taking a part of the sequence (in particular a border part like a tail or beginning) and appending it to the sequence, e.g. at the beginning or end, for example in time domain or frequency domain. Thus, a cyclic extended sequence may represent a (root) sequence and at least a part repetition of the (root) sequence. Operations described may be combined, in any order, in particular a shift and a cyclic extension. A cyclic shift in a domain may comprise shifting the sequence in the domain within an interval, such that the total number of sequence elements is constant, and the sequence is shifted as if the interval represented a ring (e.g., such that starting from the same sequence element, which may appear at different location in the interval), the order of elements is the same if the borders of the intervals are considered to be continuous, such that leaving one end of the interval leads to entering the interval at the other end). Processing and/or operating on with a code may correspond to constructing a sequence out of copies of a root sequence, wherein each copy is multiplied and/or operated on with an element of the code. Multiplying with an element of a code may represent and/or correspond to a shift (e.g., constant or linear or cyclic) in phase and/or frequency and/or time domain, depending on representation. In the context of this disclosure, a sequence being based on and/or being constructed and/or processed may be any sequence that would result from such construction or processing, even if the sequence is just read from memory. Any isomorphic or equivalent or corresponding way to arrive at the sequence is considered to be included by such terminology; the construction thus may be considered to define the characteristics of the sequence and/or the sequence, not necessarily a specific way to construct them, as there may be multiple equivalent ways that are mathematically equivalent. Thus, a sequence “based on” or “constructed” or similar terminology may be considered to correspond to the sequence being “represented by” or “may be represented by” or “representable as”.

A root sequence for a signalling sequence associated to one allocation unit may be basis for construction of a larger sequence. In this case, the larger sequence and/or the root sequence basis for its construction may be considered root sequence for signalling sequences associated to other allocation units.

For OFDM or SC-FDM or communication based thereon, each element of a signalling sequence may be mapped to a subcarrier; in general, for SC-based signalling, a corresponding mapping in time domain may be utilised (such that each element may use essentially the full synchronisation bandwidth). A signalling sequence may comprise (ordered) modulation symbols, each modulation symbol representing a value of the sequence it is based on, e.g. based on the modulation scheme used and/or in a phase or constellation diagram; for some sequences like Zadoff-Chu sequences, there may be a mapping between non-integer sequence elements and transmitted waveform, which may not be represented in the context of a modulation scheme like BPSK or QPSK or higher.

A signalling sequence of an allocation unit may be based on a sequence root, e.g. a root sequence. A sequence root in general may represent or indicate a base for deriving or determining a signalling sequence; the root may be associated to, and/or represent a sequence directly, and/or indicate or represent a base sequence and/or seed. Examples of sequence roots may comprise a Zadoff Chu root sequence, a sequence seed, e.g. a seed for a Gold sequence, or a Golay complimentary sequence. A signalling sequence may be derived or derivable from, and/or be based on, a sequency root, e.g. based on a code, which may represent a shift or operation or processing on the root sequence or a sequence indicated by the sequence root, e.g. to provide the signalling sequence; the signalling sequence may be based on such shifted or processed or operated on root sequence. The code may in particular represent a cyclic shift and/or phase shift and/or phase ramp (e.g., an amount for such). The code may assign one operation or shift for each allocation unit.

In general, a signalling sequence associated to an allocation unit (and/or the allocation units) associated to control signalling (and/or reference signalling) may be based on a root sequence which may be a M-sequence or Zadoff-Chu sequence, or a Gold or Golay sequence, or another sequence with suitable characteristics regarding correlation and/or interference (e.g., self-interference and/or interference with other or neighboring transmitters). Different sequences may be used as root sequences for different signalling sequences, or the same sequence may be used. If different sequences are used, they may be of the same type (Gold, Golay, M- or Zadoff-Chu, for example). The (signalling and/or root) sequences may correspond to or be time-domain sequences, e.g. time domain Zadoff-Chu and/or time-domain M sequences.

In some cases, a shifted object like a signalling or signals or sequences or information may be shifted, e.g. relative to a predecessor (e.g., one is subject to a shift, and the shifted version is used), or relative to another (e.g., one associated to one signalling or allocation unit may be shifted to another associated to a second signalling or allocation unit, both may be used). One possible way of shifting is operating a code on it, e.g. to multiply each element of a shifting object with a factor. A ramping (e.g. multiplying with a monotonously increasing or periodic factor) may be considered an example of shifting.

Another is a cyclic shift in a domain or interval. A cyclic shift (or circular shift) may correspond to a rearrangement of the elements in the shifting object, corresponding to moving the final element or elements to the first position, while shifting all other entries to the next position, or by performing the inverse operation (such that the shifted object as the result will have the same elements as the shifting object, in a shifted but similar order). Shifting in general may be specific to an interval in a domain, e.g. an allocation unit in time domain, or a bandwidth in frequency domain. For example, it may be considered that signals or modulation symbols in an allocation unit are shifted, such that the order of the modulation symbols or signals is shifted in the allocation unit. In another example, allocation units may be shifted, e.g. in a larger time interval—this may leave signals in the allocation units unshifted with reference to the individual allocation unit, but may change the order of the allocation units. Domains for shifting may for example be time domain and/or phase domain and/or frequency domain. Multiple shifts in the same domain or different domains, and/or the same interval or different intervals (differently sized intervals, for example) may be performed.

Reference signalling may have a type. Types of reference signalling may include synchronisation signalling, and/or DM-RS (used to facilitate demodulation of associated data signalling and/or control signalling), and/or PT-RS (used to facilitate phase tracking of associated data signalling and/or control signalling, e.g. within a time interval or symbol or allocation unit carrying such signalling), and/or CSI-RS (e.g., used for channel estimation and/or reporting). It may be considered that PT-RS are inserted into a bit sequence, or a modulation symbol sequence, which may represent data. For example, PT-RS may be mapped onto subcarriers of a symbol also carrying data symbols. Accordingly, PT-RS insertion may be optimised for hardware implementations. In some cases, PT-RS may be modulated differently and/or independently of the modulation symbols representing data (or data bits).

In general, a numerology and/or subcarrier spacing may indicate the bandwidth (in frequency domain) of a subcarrier of a carrier, and/or the number of subcarriers in a carrier and/or the numbering of the subcarriers in a carrier, and/or the symbol time length. Different numerologies may in particular be different in the bandwidth of a subcarrier. In some variants, all the subcarriers in a carrier have the same bandwidth associated to them. The numerology and/or subcarrier spacing may be different between carriers in particular regarding the subcarrier bandwidth. A symbol time length, and/or a time length of a timing structure pertaining to a carrier may be dependent on the carrier frequency, and/or the subcarrier spacing and/or the numerology. In particular, different numerologies may have different symbol time lengths, even on the same carrier.

Signalling may generally comprise one or more (e.g., modulation) symbols and/or signals and/or messages. A signal may comprise or represent one or more bits. An indication may represent signalling, and/or be implemented as a signal, or as a plurality of signals. One or more signals may be included in and/or represented by a message. signalling, in particular control signalling, may comprise a plurality of signals and/or messages, which may be transmitted on different carriers and/or be associated to different signalling processes, e.g. representing and/or pertaining to one or more such processes and/or corresponding information. An indication may comprise signalling, and/or a plurality of signals and/or messages and/or may be comprised therein, which may be transmitted on different carriers and/or be associated to different acknowledgement signalling processes, e.g. representing and/or pertaining to one or more such processes. signalling associated to a channel may be transmitted such that represents signalling and/or information for that channel, and/or that the signalling is interpreted by the transmitter and/or receiver to belong to that channel. Such signalling may generally comply with transmission parameters and/or format/s for the channel.

An antenna arrangement may comprise one or more antenna elements (radiating elements), which may be combined in antenna arrays. An antenna array or subarray may comprise one antenna element, or a plurality of antenna elements, which may be arranged e.g. two dimensionally (for example, a panel) or three dimensionally. It may be considered that each antenna array or subarray or element is separately controllable, respectively that different antenna arrays are controllable separately from each other. A single antenna element/radiator may be considered the smallest example of a subarray. Examples of antenna arrays comprise one or more multi-antenna panels or one or more individually controllable antenna elements. An antenna arrangement may comprise a plurality of antenna arrays. It may be considered that an antenna arrangement is associated to a (specific and/or single) radio node, e.g. a configuring or informing or scheduling radio node, e.g. to be controlled or controllable by the radio node. An antenna arrangement associated to a UE or terminal may be smaller (e.g., in size and/or number of antenna elements or arrays) than the antenna arrangement associated to a network node. Antenna elements of an antenna arrangement may be configurable for different arrays, e.g. to change the beamforming characteristics. In particular, antenna arrays may be formed by combining one or more independently or separately controllable antenna elements or subarrays. The beams may be provided by analog beamforming, or in some variants by digital beamforming, or by hybrid beamforming combing analog and digital beamforming. The informing radio nodes may be configured with the manner of beam transmission, e.g. by transmitting a corresponding indicator or indication, for example as beam identify indication. However, there may be considered cases in which the informing radio node/s are not configured with such information, and/or operate transparently, not knowing the way of beamforming used. An antenna arrangement may be considered separately controllable in regard to the phase and/or amplitude/power and/or gain of a signal feed to it for transmission, and/or separately controllable antenna arrangements may comprise an independent or separate transmit and/or receive unit and/or ADC (Analog-Digital-Converter, alternatively an ADC chain) or DCA (Digital-to-Analog Converter, alternatively a DCA chain) to convert digital control information into an analog antenna feed for the whole antenna arrangement (the ADC/DCA may be considered part of, and/or connected or connectable to, antenna circuitry) or vice versa. A scenario in which an ADC or DCA is controlled directly for beamforming may be considered an analog beamforming scenario; such controlling may be performed after encoding/decoding and/or after modulation symbols have been mapped to resource elements. This may be on the level of antenna arrangements using the same ADC/DCA, e.g. one antenna element or a group of antenna elements associated to the same ADC/DCA. Digital beamforming may correspond to a scenario in which processing for beamforming is provided before feeding signalling to the ADC/DCA, e.g. by using one or more precoder/s and/or by precoding information, for example before and/or when mapping modulation symbols to resource elements. Such a precoder for beamforming may provide weights, e.g. for amplitude and/or phase, and/or may be based on a (precoder) codebook, e.g. selected from a codebook. A precoder may pertain to one beam or more beams, e.g. defining the beam or beams. The codebook may be configured or configurable, and/or be predefined. DFT beamforming may be considered a form of digital beamforming, wherein a DFT procedure is used to form one or more beams. Hybrid forms of beamforming may be considered.

A beam may be defined by a spatial and/or angular and/or spatial angular distribution of radiation and/or a spatial angle (also referred to as solid angle) or spatial (solid) angle distribution into which radiation is transmitted (for transmission beamforming) or from which it is received (for reception beamforming). Reception beamforming may comprise only accepting signals coming in from a reception beam (e.g., using analog beamforming to not receive outside reception beam/s), and/or sorting out signals that do not come in in a reception beam, e.g. in digital postprocessing, e.g. digital beamforming. A beam may have a solid angle equal to or smaller than 4*pi sr (4*pi correspond to a beam covering all directions), in particular smaller than 2*pi, or pi, or pi/2, or pi/4 or pi/8 or pi/16. In particular for high frequencies, smaller beams may be used. Different beams may have different directions and/or sizes (e.g., solid angle and/or reach). A beam may have a main direction, which may be defined by a main lobe (e.g., center of the main lobe, e.g. pertaining to signal strength and/or solid angle, which may be averaged and/or weighted to determine the direction), and may have one or more sidelobes. A lobe may generally be defined to have a continuous or contiguous distribution of energy and/or power transmitted and/or received, e.g. bounded by one or more contiguous or contiguous regions of zero energy (or practically zero energy). A main lobe may comprise the lobe with the largest signal strength and/or energy and/or power content. However, sidelobes usually appear due to limitations of beamforming, some of which may carry signals with significant strength, and may cause multi-path effects. A sidelobe may generally have a different direction than a main lobe and/or other side lobes, however, due to reflections a sidelobe still may contribute to transmitted and/or received energy or power. A beam may be swept and/or switched over time, e.g., such that its (main) direction is changed, but its shape (angular/solid angle distribution) around the main direction is not changed, e.g. from the transmitter's views for a transmission beam, or the receiver's view for a reception beam, respectively. Sweeping may correspond to continuous or near continuous change of main direction (e.g., such that after each change, the main lobe from before the change covers at least partly the main lobe after the change, e.g. at least to 50 or 75 or 90 percent). Switching may correspond to switching direction non-continuously, e.g. such that after each change, the main lobe from before the change does not cover the main lobe after the change, e.g. at most to 50 or 25 or 10 percent.

Signal strength may be a representation of signal power and/or signal energy, e.g. as seen from a transmitting node or a receiving node. A beam with larger strength at transmission (e.g., according to the beamforming used) than another beam does may not necessarily have larger strength at the receiver, and vice versa, for example due to interference and/or obstruction and/or dispersion and/or absorption and/or reflection and/or attrition or other effects influencing a beam or the signalling it carries. Signal quality may in general be a representation of how well a signal may be received over noise and/or interference. A beam with better signal quality than another beam does not necessarily have a larger beam strength than the other beam. Signal quality may be represented for example by SIR, SNR, SINR, BER, BLER, Energy per resource element over noise/interference or another corresponding quality measure. Signal quality and/or signal strength may pertain to, and/or may be measured with respect to, a beam, and/or specific signalling carried by the beam, e.g. reference signalling and/or a specific channel, e.g. a data channel or control channel. Signal strength may be represented by received signal strength, and/or relative signal strength, e.g. in comparison to a reference signal (strength).

Uplink or sidelink signalling may be OFDMA (Orthogonal Frequency Division Multiple Access) or SC-FDMA (Single Carrier Frequency Division Multiple Access) signalling. Downlink signalling may in particular be based on and/or represent OFDM signalling and/or SC-FDM. However, signalling is not limited thereto (Filter-Bank based signalling and/or Single-Carrier based signalling, e.g. SC-FDE signalling, may be considered alter-natives).

A radio node may generally be considered a device or node adapted for wireless and/or radio (and/or millimeter wave) frequency communication, and/or for communication utilising an air interface, e.g. according to a communication standard.

A radio node may be a network node, or a user equipment or terminal. A network node may be any radio node of a wireless communication network, e.g. a base station and/or gNodeB (gNB) and/or eNodeB (eNB) and/or relay node and/or micro/nano/pico/femto node and/or transmission point (TP) and/or access point (AP) and/or other node, in particular for a RAN or other wireless communication network as described herein.

The terms user equipment (UE) and terminal may be considered to be interchangeable in the context of this disclosure. A wireless device, user equipment or terminal may represent an end device for communication utilising the wireless communication network, and/or be implemented as a user equipment according to a standard. Examples of user equipments may comprise a phone like a smartphone, a personal communication device, a mobile phone or terminal, a computer, in particular laptop, a sensor or machine with radio capability (and/or adapted for the air interface), in particular for MTC (Machine-Type-Communication, sometimes also referred to M2M, Machine-To-Machine), or a vehicle adapted for wireless communication. A user equipment or terminal may be mobile or stationary. A wireless device generally may comprise, and/or be implemented as, processing circuitry and/or radio circuitry, which may comprise one or more chips or sets of chips. The circuitry and/or circuitries may be packaged, e.g. in a chip housing, and/or may have one or more physical interfaces to interact with other circuitry and/or for power supply. Such a wireless device may be intended for use in a user equipment or terminal.

A radio node may generally comprise processing circuitry and/or radio circuitry. A radio node, in particular a network node, may in some cases comprise cable circuitry and/or communication circuitry, with which it may be connected or connectable to another radio node and/or a core network.

Circuitry may comprise integrated circuitry. Processing circuitry may comprise one or more processors and/or controllers (e.g., microcontrollers), and/or ASICs (Application Specific Integrated Circuitry) and/or FPGAs (Field Programmable Gate Array), or similar. It may be considered that circuitry like processing circuitry comprises, and/or is (operatively) connected or connectable to one or more memories or memory arrangements. A memory arrangement may comprise one or more memories. A memory may be adapted to store digital information. Examples for memories comprise volatile and non-volatile memory, and/or Random Access Memory (RAM), and/or Read-Only-Memory (ROM), and/or magnetic and/or optical memory, and/or flash memory, and/or hard disk memory, and/or EPROM or EEPROM (Erasable Programmable ROM or Electrically Erasable Programmable ROM).

Radio circuitry and/or antenna circuitry may comprise one or more transmitters and/or receivers and/or transceivers (a transceiver may operate or be operable as transmitter and receiver, and/or may comprise joint or separated circuitry for receiving and transmitting, e.g. in one package or housing), and/or may comprise one or more amplifiers and/or oscillators and/or filters, and/or may comprise, and/or be connected or connectable to antenna circuitry and/or one or more antennas and/or antenna arrays. An antenna array may comprise one or more antennas, which may be arranged in a dimensional array, e.g. 2D or 3D array, and/or antenna panels. A remote radio head (RRH) may be considered as an example of an antenna array. However, in some variants, an RRH may be also be implemented as a network node, depending on the kind of circuitry and/or functionality implemented therein.

Communication circuitry may comprise radio circuitry and/or cable circuitry. Communication circuitry generally may comprise one or more interfaces, which may be air inter-face/s and/or cable interface/s and/or optical interface/s, e.g. laser-based. Interface/s may be in particular packet-based. Cable circuitry and/or a cable interfaces may comprise, and/or be connected or connectable to, one or more cables (e.g., optical fiber-based and/or wire-based), which may be directly or indirectly (e.g., via one or more intermediate systems and/or interfaces) be connected or connectable to a target, e.g. controlled by communication circuitry and/or processing circuitry.

Any one or all of the modules disclosed herein may be implemented in software and/or firmware and/or hardware. Different modules may be associated to different components of a radio node, e.g. different circuitries or different parts of a circuitry. It may be considered that a module is distributed over different components and/or circuitries. A program product as described herein may comprise the modules related to a device on which the program product is intended (e.g., a user equipment or network node) to be executed (the execution may be performed on, and/or controlled by the associated circuitry).

A wireless communication network may be or comprise a radio access network and/or a backhaul network (e.g. a relay or backhaul network or an IAB network), and/or a Radio Access Network (RAN) in particular according to a communication standard. A communication standard may in particular a standard according to 3GPP and/or 5G, e.g. according to NR or LTE, in particular LTE Evolution.

A wireless communication network may be and/or comprise a Radio Access Network (RAN), which may be and/or comprise any kind of cellular and/or wireless radio network, which may be connected or connectable to a core network. The approaches described herein are particularly suitable for a 5G network, e.g. LTE Evolution and/or NR (New Radio), respectively successors thereof. A RAN may comprise one or more network nodes, and/or one or more terminals, and/or one or more radio nodes. A network node may in particular be a radio node adapted for radio and/or wireless and/or cellular communication with one or more terminals. A terminal may be any device adapted for radio and/or wireless and/or cellular communication with or within a RAN, e.g. a user equipment (UE) or mobile phone or smartphone or computing device or vehicular communication device or device for machine-type-communication (MTC), etc. A terminal may be mobile, or in some cases stationary. A RAN or a wireless communication network may comprise at least one network node and a UE, or at least two radio nodes. There may be generally considered a wireless communication network or system, e.g. a RAN or RAN system, comprising at least one radio node, and/or at least one network node and at least one terminal.

Transmitting in downlink may pertain to transmission from the network or network node to the terminal. Transmitting in uplink may pertain to transmission from the terminal to the network or network node. Transmitting in sidelink may pertain to (direct) transmission from one terminal to another. Uplink, downlink and sidelink (e.g., sidelink transmission and reception) may be considered communication directions. In some variants, uplink and downlink may also be used to described wireless communication between network nodes, e.g. for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

A signalling characteristic, r.g., associated to control signalling, may be based on a type or format of a scheduling grant and/or scheduling assignment, and/or type of allocation, and/or timing of acknowledgement signalling and/or the scheduling grant and/or scheduling assignment, and/or resources associated to acknowledgement signalling and/or the scheduling grant and/or scheduling assignment. For example, if a specific format for a scheduling grant (scheduling or allocating the allocated resources) or scheduling assignment (scheduling the subject transmission for acknowledgement signalling) is used or detected, the first or second communication resource may be used. Type of allocation may pertain to dynamic allocation (e.g., using DCI/PDCCH) or semi-static allocation (e.g., for a configured grant). Timing of acknowledgement signalling may pertain to a slot and/or symbol/s the signalling is to be transmitted. Resources used for acknowledgement signalling may pertain to the allocated resources. Timing and/or resources associated to a scheduling grant or assignment may represent a search space or CORESET (a set of resources configured for reception of PDCCH transmissions) in which the grant or assignment is received. Thus, which transmission resource to be used may be based on implicit conditions, requiring low signalling overhead.

Scheduling may comprise indicating, e.g. with control signalling like DCI or SCI signalling and/or signalling on a control channel like PDCCH or PSCCH, one or more scheduling opportunities of a configuration intended to carry data signalling or subject signalling. The configuration may be represented or representable by, and/or correspond to, a table. A scheduling assignment may for example point to an opportunity of the reception allocation configuration, e.g. indexing a table of scheduling opportunities. In some cases, a reception allocation configuration may comprise 15 or 16 scheduling opportunities. The configuration may in particular represent allocation in time. It may be considered that the reception allocation configuration pertains to data signalling, in particular on a physical data channel like PDSCH or PSSCH. In general, the reception allocation configuration may pertain to downlink signalling, or in some scenarios to sidelink signalling. Control signalling scheduling subject transmission like data signalling may point and/or index and/or refer to and/or indicate a scheduling opportunity of the reception allocation configuration. It may be considered that the reception allocation configuration is configured or configurable with higher-layer signalling, e.g. RRC or MAC layer signalling. The reception allocation configuration may be applied and/or applicable and/or valid for a plurality of transmission timing intervals, e.g. such that for each interval, one or more opportunities may be indicated or allocated for data signalling. These approaches allow efficient and flexible scheduling, which may be semi-static, but may updated or reconfigured on useful timescales in response to changes of operation conditions.

Signalling may generally be considered to represent an electromagnetic wave structure (e.g., over a time interval and frequency interval), which is intended to convey information to at least one specific or generic (e.g., anyone who might pick up the signalling) target. A process of signalling may comprise transmitting the signalling. Transmitting signalling, in particular control signalling or communication signalling, e.g. comprising or representing acknowledgement signalling and/or resource requesting information, may comprise encoding and/or modulating. Encoding and/or modulating may comprise error detection coding and/or forward error correction encoding and/or scrambling. Receiving control signalling may comprise corresponding decoding and/or demodulation. Error detection coding may comprise, and/or be based on, parity or checksum approaches, e.g. CRC (Cyclic Redundancy Check). Forward error correction coding may comprise and/or be based on for example turbo coding and/or Reed-Muller coding, and/or polar coding and/or LDPC coding (Low Density Parity Check). The type of coding used may be based on the channel (e.g., physical channel) the coded signal is associated to. A code rate may represent the ratio of the number of information bits before encoding to the number of encoded bits after encoding, considering that encoding adds coding bits for error detection coding and forward error correction. Coded bits may refer to information bits (also called systematic bits) plus coding bits.

A resource element may generally describe the smallest individually usable and/or encodable and/or decodable and/or modulatable and/or demodulatable time-frequency resource, and/or may describe a time-frequency resource covering a symbol time length in time and a subcarrier in frequency. A signal may be allocatable and/or allocated to a resource element. A subcarrier may be a subband of a carrier, e.g. as defined by a standard. A carrier may define a frequency and/or frequency band for transmission and/or reception. In some variants, a signal (jointly encoded/modulated) may cover more than one resource elements. A resource element may generally be as defined by a corresponding standard, e.g. NR or LTE. As symbol time length and/or subcarrier spacing (and/or numerology) may be different between different symbols and/or subcarriers, different resource elements may have different extension (length/width) in time and/or frequency domain, in particular resource elements pertaining to different carriers.

A resource generally may represent a time-frequency and/or code resource, on which signalling, e.g. according to a specific format, may be communicated, for example transmitted and/or received, and/or be intended for transmission and/or reception.

A resource structure may general represent a structure in time and/or frequency domain, in particular representing a time interval and a frequency interval. A resource structure may comprise and/or be comprised of resource elements, and/or the time interval of a resource structure may comprise and/or be comprised of symbol time interval/s, and/or the frequency interval of a resource structure may comprise and/or be comprised of sub-carrier/s. A resource element may be considered an example for a resource structure, a slot or mini-slot or a Physical Resource Block (PRB) or parts thereof may be considered others. A resource structure may be associated to a specific channel, e.g. a PUSCH or PUCCH, in particular resource structure smaller than a slot or PRB.

Examples of a resource structure in frequency domain comprise a bandwidth or band, or a bandwidth part. A bandwidth part may be a part of a bandwidth available for a radio node for communicating, e.g. due to circuitry and/or configuration and/or regulations and/or a standard. A bandwidth part may be configured or configurable to a radio node. In some variants, a bandwidth part may be the part of a bandwidth used for communicating, e.g. transmitting and/or receiving, by a radio node. The bandwidth part may be smaller than the bandwidth (which may be a device bandwidth defined by the circuitry/configuration of a device, and/or a system bandwidth, e.g. available for a RAN). It may be considered that a bandwidth part comprises one or more resource blocks or resource block groups, in particular one or more PRBs or PRB groups. A bandwidth part may pertain to, and/or comprise, one or more carriers.

A carrier may generally represent a frequency range or band and/or pertain to a central frequency and an associated frequency interval. It may be considered that a carrier comprises a plurality of subcarriers. A carrier may have assigned to it a central frequency or center frequency interval, e.g. represented by one or more subcarriers (to each subcarrier there may be generally assigned a frequency bandwidth or interval). Different carriers may be non-overlapping, and/or may be neighboring in frequency domain.

It should be noted that the term “radio” in this disclosure may be considered to pertain to wireless communication in general, and may also include wireless communication utilising 1395 millimeter waves, in particular above one of the thresholds 10 GHz or 20 GHz or 24 GHz or 50 GHz or 52 GHz or 52.6 GHz or 60 GHz or 72 GHz or 100 GHz or 114 GHz. Such communication may utilise one or more carriers, e.g. in FDD and/or carrier aggregation.

Upper frequency boundaries may correspond to 300 GHz or 200 GHz or 120 GHz or any of the thresholds larger than the one representing the lower frequency boundary. A radio node, in particular a network node or a terminal, may generally be any device adapted for transmitting and/or receiving radio and/or wireless signals and/or data, in particular communication data, in particular on at least one carrier. The at least one carrier may comprise a carrier accessed based on an LBT procedure (which may be called LBT carrier), e.g., an unlicensed carrier. It may be considered that the carrier is part of a carrier aggregate.

Receiving or transmitting on a cell or carrier may refer to receiving or transmitting utilizing a frequency (band) or spectrum associated to the cell or carrier. A cell may generally comprise and/or be defined by or for one or more carriers, in particular at least one carrier for UL communication/transmission (called UL carrier) and at least one carrier for 1410 DL communication/transmission (called DL carrier). It may be considered that a cell comprises different numbers of UL carriers and DL carriers. Alternatively, or additionally, a cell may comprise at least one carrier for UL communication/transmission and DL communication/transmission, e.g., in TDD-based approaches.

In general, a symbol may represent and/or be associated to a symbol time length, which may be dependent on the carrier and/or subcarrier spacing and/or numerology of the associated carrier. Accordingly, a symbol may be considered to indicate a time interval having a symbol time length in relation to frequency domain. A symbol time length may be dependent on a carrier frequency and/or bandwidth and/or numerology and/or subcarrier spacing of, or associated to, a symbol. Accordingly, different symbols may have different symbol time lengths. In particular, numerologies with different subcarrier spacings may have different symbol time length. Generally, a symbol time length may be based on, and/or include, a guard time interval or cyclic extension, e.g. prefix or postfix.

A transmission may generally pertain to a specific channel and/or specific resources, in particular with a starting symbol and ending symbol in time, covering the interval therebetween. A scheduled transmission may be a transmission scheduled and/or expected and/or for which resources are scheduled or provided or reserved. However, not every scheduled transmission has to be realized. For example, a scheduled downlink transmission may not be received, or a scheduled uplink transmission may not be transmitted due to power limitations, or other influences (e.g., a channel on an unlicensed carrier being occupied). A transmission may be scheduled for a transmission timing substructure (e.g., a mini-slot, and/or covering only a part of a transmission timing structure) within a transmission timing structure like a slot. A border symbol may be indicative of a symbol in the transmission timing structure at which the transmission starts or ends.

A control region of a transmission timing structure may be an interval in time and/or frequency domain for intended or scheduled or reserved for control signalling, in particular downlink control signalling, and/or for a specific control channel, e.g. a physical downlink control channel like PDCCH. The interval may comprise, and/or consist of, a number of symbols in time, which may be configured or configurable, e.g. by (UE-specific) dedicated signalling (which may be single-cast, for example addressed to or intended for a specific UE), e.g. on a PDCCH, or RRC signalling, or on a multicast or broadcast channel. In general, the transmission timing structure may comprise a control region covering a configurable number of symbols. It may be considered that in general the border symbol is configured to be after the control region in time. A control region may be associated, e.g. via configuration and/or determination, to one or more specific UEs and/or formats of PDCCH and/or DCI and/or identifiers, e.g. UE identifiers and/or RNTIs or carrier/cell identifiers, and/or be represented and/or associated to a CORESET and/or a search space.

The duration of a symbol (symbol time length or interval) of the transmission timing structure may generally be dependent on a numerology and/or carrier, wherein the numerology and/or carrier may be configurable. The numerology may be the numerology to be used for the scheduled transmission.

A transmission timing structure may comprise a plurality of symbols, and/or define an interval comprising several symbols (respectively their associated time intervals). In the context of this disclosure, it should be noted that a reference to a symbol for ease of reference may be interpreted to refer to the time domain projection or time interval or time component or duration or length in time of the symbol, unless it is clear from the context that the frequency domain component also has to be considered. Examples of transmission timing structures include slot, subframe, mini-slot (which also may be considered a substructure of a slot), slot aggregation (which may comprise a plurality of slots and may be considered a superstructure of a slot), respectively their time domain component. A transmission timing structure may generally comprise a plurality of symbols defining the time domain extension (e.g., interval or length or duration) of the transmission timing structure, and arranged neighboring to each other in a numbered sequence. A timing structure (which may also be considered or implemented as synchronisation structure) may be defined by a succession of such transmission timing structures, which may for example define a timing grid with symbols representing the smallest grid structures. A transmission timing structure, and/or a border symbol or a scheduled transmission may be determined or scheduled in relation to such a timing grid. A transmission timing structure of reception may be the transmission timing structure in which the scheduling control signalling is received, e.g. in relation to the timing grid. A transmission timing structure may in particular be a slot or subframe or in some cases, a mini-slot.

Signalling utilising, and/or on and/or associated to, resources or a resource structure may be signalling covering the resources or structure, signalling on the associated frequency/ies and/or in the associated time interval/s. It may be considered that a signalling resource structure comprises and/or encompasses one or more substructures, which may be associated to one or more different channels and/or types of signalling and/or comprise one or more holes (resource element/s not scheduled for transmissions or reception of transmissions). A resource substructure, e.g. a feedback resource structure, may generally be continuous in time and/or frequency, within the associated intervals. It may be considered that a substructure, in particular a feedback resource structure, represents a rectangle filled with one or more resource elements in time/frequency space. However, in some cases, a resource structure or substructure, in particular a frequency resource range, may represent a non-continuous pattern of resources in one or more domains, e.g. time and/or frequency. The resource elements of a substructure may be scheduled for associated signalling.

Example types of signalling comprise signalling of a specific communication direction, in particular, uplink signalling, downlink signalling, sidelink signalling, as well as reference signalling (e.g., SRS or CRS or CSI-RS), communication signalling, control signalling, and/or signalling associated to a specific channel like PUSCH, PDSCH, PUCCH, PDCCH, PSCCH, PSSCH, etc.).

In the context of this disclosure, there may be distinguished between dynamically scheduled or aperiodic transmission and/or configuration, and semi-static or semi-persistent or periodic transmission and/or configuration. The term “dynamic” or similar terms may generally pertain to configuration/transmission valid and/or scheduled and/or configured for (relatively) short timescales and/or a (e.g., predefined and/or configured and/or limited and/or definite) number of occurrences and/or transmission timing structures, e.g. one or more transmission timing structures like slots or slot aggregations, and/or for one or more (e.g., specific number) of transmission/occurrences. Dynamic configuration may be based on low-level signalling, e.g. control signalling on the physical layer and/or MAC layer, in particular in the form of DCI or SCI. Periodic/semi-static may pertain to longer timescales, e.g. several slots and/or more than one frame, and/or a non-defined number of occurrences, e.g., until a dynamic configuration contradicts, or until a new periodic configuration arrives. A periodic or semi-static configuration may be based on, and/or be configured with, higher-layer signalling, in particular RCL layer signalling and/or RRC signalling and/or MAC signalling.

In this disclosure, for purposes of explanation and not limitation, specific details are set forth (such as particular network functions, processes and signalling steps) in order to provide a thorough understanding of the technique presented herein. It will be apparent to one skilled in the art that the present concepts and aspects may be practiced in other variants and variants that depart from these specific details.

For example, the concepts and variants are partially described in the context of Long Term Evolution (LTE) or LTE-Advanced (LTE-A) or New Radio mobile or wireless communications technologies; however, this does not rule out the use of the present concepts and aspects in connection with additional or alternative mobile communication technologies such as the Global System for Mobile Communications (GSM) or IEEE standards as IEEE 802.11ad or IEEE 802.11 ay. While described variants may pertain to certain Technical Specifications (TSs) of the Third Generation Partnership Project (3GPP), it will be appreciated that the present approaches, concepts and aspects could also be realized in connection with different Performance Management (PM) specifications.

Moreover, those skilled in the art will appreciate that the services, functions and steps explained herein may be implemented using software functioning in conjunction with a programmed microprocessor, or using an Application Specific Integrated Circuit (ASIC), a Digital Signal Processor (DSP), a Field Programmable Gate Array (FPGA) or general purpose computer. It will also be appreciated that while the variants described herein are elucidated in the context of methods and devices, the concepts and aspects presented herein may also be embodied in a program product as well as in a system comprising control circuitry, e.g. a computer processor and a memory coupled to the processor, wherein the memory is encoded with one or more programs or program products that execute the services, functions and steps disclosed herein.

It is believed that the advantages of the aspects and variants presented herein will be fully understood from the foregoing description, and it will be apparent that various changes may be made in the form, constructions and arrangement of the exemplary aspects thereof without departing from the scope of the concepts and aspects described herein or without sacrificing all of its advantageous effects. The aspects presented herein can be varied in many ways.

### SOME USEFUL ABBREVIATIONS COMPRISE

Abbreviation Explanation
AAS Advanced Antenna Array
ACK/NACK Acknowledgment/Negative Acknowledgement
ADC Analog-to-Digital Converter
ARQ Automatic Repeat reQuest
BER Bit Error Rate
BFIC Beam forming integrated circuit
BLER Block Error Rate
BPSK Binary Phase Shift Keying
BWP BandWidth Part
CAZAC Constant Amplitude Zero Cross Correlation
CB Code Block
CBB Code Block Bundle
CBG Code Block Group
CDM Code Division Multiplex
CM Cubic Metric
CORESET Control Resource Set
CQI Channel Quality Information
CRC Cyclic Redundancy Check
CRS Common reference signal
CSI Channel State Information
CSI-RS Channel state information reference signal
DAI Downlink Assignment Indicator
DCA Digital-to-Analog Converter
DCI Downlink Control Information
DFE Digital Front-End
DFT Discrete Fourier Transform
DFTS-FDM DFT-spread-FDM
DM(-)RS Demodulation reference signal(ing)
DUT Device Under test
eMBB enhanced Mobile BroadBand
FDD Frequency Division Duplex
FDE Frequency Domain Equalisation
FDF Frequency Domain Filtering
FDM Frequency Division Multiplex
HARQ Hybrid Automatic Repeat Request
IAB Integrated Access and Backhaul
IF Intermediate frequency
IFFT Inverse Fast Fourier Transform
Im Imaginary part, e.g. for pi/2*BPSK modulation
IR Impulse Response
ISI Inter Symbol Interference
LNA Low noise amplifier
LO Local Oscillator
LPF Linear Polarised Feed
MBB Mobile Broadband
MCS Modulation and Coding Scheme
MIMO Multiple-input-multiple-output
MRC Maximum-ratio combining
MRT Maximum-ratio transmission
MU-MIMO Multiuser multiple-input-multiple-output
OCC Orthogonal Cover Code
OFDM/A Orthogonal Frequency Division Multiplex/Multiple Access
PA Power Amplifier
PAPR Peak to Average Power Ratio
PDCCH Physical Downlink Control Channel
PDSCH Physical Downlink Shared Channel
PGA Programmable Gain Amplifier
PLL Phase locked loop
PRACH Physical Random Access CHannel
PRB Physical Resource Block
PUCCH Physical Uplink Control Channel
PUSCH Physical Uplink Shared Channel
(P)SCCH (Physical) Sidelink Control Channel
PSS Primary Synchronisation Signal(ing)
PT-RS Phase Tracking Reference signalling
(P)SSCH (Physical) Sidelink Shared Channel
QAM Quadrature Amplitude Modulation
QPSK Quadrature Phase Shift Keying
PAAM Phased Array Antenna Module
PSD Power Spectral Density
RAN Radio Access Network
RAT Radio Access Technology
RB Resource Block
RE Resource Element
Re Real part (e.g., for pi/2*BPSK) modulation
RF Radio Frequency, e.g. 200 MHz or more
RNTI Radio Network Temporary Identifier
RRC Radio Resource Control
RS Reference Signal
RX Receiver, Reception, Reception-related/side
SA Scheduling Assignment
SC-FDE Single Carrier Frequency Domain Equalisation
SC-FDM/A Single Carrier Frequency Division Multiplex/Multiple Access
SCI Sidelink Control Information
SDM Spatial Domain Multiplexing
SINR Signal-to-interference-plus-noise ratio
SIR Signal-to-interference ratio
SNR Signal-to-noise-ratio
SR Scheduling Request
SRS Sounding Reference Signal(ing)
SSS Secondary Synchronisation Signal(ing)
SU-MIMO Single User Multiple Input Multiple Output
SVD Singular-value decomposition
TB Transport Block
TDD Time Division Duplex
TDM Time Division Multiplex
T-RS Tracking Reference signalling or Timing Reference signalling
TX Transmitter, Transmission, Transmission-related/side
UCI Uplink Control Information
UE User Equipment
URLLC Ultra Low Latency High Reliability Communication
VL-MIMO Very-large multiple-input-multiple-output
WD Wireless Device
ZF Zero Forcing
ZP Zero-Power, e.g. muted CSI-RS symbol

Abbreviations may be considered to follow 3GPP usage if applicable.

1. An antenna circuitry for a radio node, the antenna circuitry being at least one of (a) connected or connectable to, and (b) included in, an antenna arrangement comprising a plurality of antenna subarrays, the antenna circuitry being arranged to connect each of one or both of a plurality of Digital-to-Analog, Converters DACs, and Analog-to Digital Converters, ADCs, to a different one of the plurality of antenna subarrays for signal transmission, the antenna circuitry comprising:
a calibration network, the calibration network being configured to provide signalling from one or more of the DACs to one or more of the ADCs.

2. The antenna circuitry according to claim 1, wherein a connection between a DAC and a subarray is represented by a transmission line for transmission of signalling by the subarray utilising one or both of the antenna circuitry, and a connection between an ADC and the subarray is represented by a reception line for reception of signalling by the subarray utilising the antenna circuitry.

3. The antenna circuitry according to claim 1, the calibration network being controllable to provide signalling from one DAC to a plurality of ADCs.

4. The antenna circuitry according to claim 1, the calibration network being controllable to provide signalling from a plurality of DACs to one ADC.

5. The antenna circuitry according to claim 1, the antenna circuitry being configured to perform calibration utilising the calibration network.

6. The antenna circuitry according to claim 1, the antenna circuitry being configured to perform calibration based on a reference calibration.

7. The antenna circuitry according to claim 1, the antenna circuitry configured to perform calibration based on calibration signalling transmitted utilizing the antenna circuitry.

8. The antenna circuitry according to claim 1, wherein the antenna circuitry provides Intermediate Frequency, IF, signal processing.

9. The antenna circuitry according to claim 1, wherein one or both each DAC is associated to a different one of the plurality of subarrays, and each ADC is associated to a different one of the subarrays.

10. The antenna circuitry according to claim 1, the antenna circuitry being configured to perform calibration based on a schedule and/or temperature drift and/or temperature measurement.

11. A radio node for a wireless communication network, the radio node comprising antenna circuitry, the antenna circuitry being at least one of (a) connected or connectable to, and (b) included in, an antenna arrangement comprising a plurality of antenna subarrays, the antenna circuitry being arranged to connect each of one or both of a plurality of Digital-to-Analog Converters, DACs, and Analog-to Digital Converters, ADCs, to a different one of the plurality of antenna subarrays for signal transmission, the antenna circuitry comprising:
a calibration network, the calibration network being configured to provide signalling from one or more of the DACs to one or more of the ADCs.

12. The radio node according to claim 11, wherein the radio node is a network node or wireless device.

13. A method of operating a radio node, the radio node comprising antenna circuitry, the antenna circuitry being at least one of (a) connected or connectable to, and (b) included in, an antenna arrangement comprising a plurality of antenna subarrays, the antenna circuitry being arranged to connect each of one or both of a plurality of Digital-to-Analog Converters, DACs, and Analog-to Digital Converters, ADCs, to a different one of the plurality of antenna subarrays for signal transmission, the method comprising:
providing signalling from one or more of the DACs to one or more of the ADCs.

14. A computer storage medium storing a computer program comprising instructions causing one or both processing circuitry and antenna circuitry to one or both control and perform a method of operating a radio node, the radio node comprising antenna circuitry, the antenna circuitry being at least one of (a) connected or connectable to, and (b) included in, an antenna arrangement comprising a plurality of antenna subarrays, the antenna circuitry being arranged to connect each of one or both of a plurality of Digital-to-Analog Converters, DACs, and Analog-to Digital Converters, ADCs, to a different one of the plurality of antenna subarrays for signal transmission, the method comprising:
providing signalling from one or more of the DACs to one or more of the ADCs.

15. (canceled)

16. The antenna circuitry according to claim 2, the calibration network being controllable to provide signalling from one DAC to a plurality of ADCs.

17. The antenna circuitry according to claim 2, the calibration network being controllable to provide signalling from a plurality of DACs to one ADC.

18. The antenna circuitry according to claim 2, the antenna circuitry being configured to perform calibration utilising the calibration network.

19. The antenna circuitry according to claim 2, the antenna circuitry being configured to perform calibration based on a reference calibration.

20. The antenna circuitry according to claim 2, the antenna circuitry configured to perform calibration based on calibration signalling transmitted utilizing the antenna circuitry.

21. The antenna circuitry according to claim 2, wherein the antenna circuitry provides Intermediate Frequency, IF, signal processing.
